(19) United States
(12) Patent Application Publication
(10) Pub. No.: US 2016/0091810 A1
(43) Pub. Date: Mar. 31, 2016

(54) ELECTROSTATIC IMAGE-DEVELOPING TONER, ELECTROSTATIC IMAGE DEVELOPER, AND TONER CARTRIDGE

(71) Applicant: FUJI XEROX CO., LTD., Tokyo (JP)

(72) Inventors: Tsutomu FURUTA, Minamiashigara-shi (JP); Yutaka SAITO, Minamiashigara-shi (JP); Yasuaki HASHIMOTO, Minamiashigara-shi (JP); Sakon TAKAHASHI, Minamiashigara-shi (JP)

(21) Appl. No.: 14/625,305

(22) Filed: Feb. 18, 2015

(30) Foreign Application Priority Data
Sep. 26, 2014 (JP) 2014-197298
Sep. 26, 2014 (JP) 2014-197300
Sep. 26, 2014 (JP) 2014-197301
Sep. 26, 2014 (JP) 2014-197302

(51) Int. Cl. G03G 9/00

(52) U.S. Cl. CPC G03G 9/08733; G03G 9/0819; G03G 9/0825

(57) ABSTRACT

There is provided an electrostatic image-developing toner containing a toner particle containing a binder resin and a release agent and having a sea-island structure involving a sea part containing the binder resin and an island part containing the release agent, in which a mode value of the distribution of the eccentricity degree B represented by the specific formula of the release agent-containing island part is from 0.75 to 0.98 and a skewness of the distribution of the eccentricity degree B is from −1.10 to −0.50; and an external additive containing a silica particle having a volume average particle diameter of 80 nm to 200 nm; wherein a bulk density of the toner is from 0.33 g/cm³ to 0.40 g/cm³.

### CROSS-REFERENCE TO RELATED APPLICATIONS

This application is based on and claims priority under 35 USC 119 from Japanese Patent Application No. 2014-197298, Japanese Patent Application No. 2014-197300, Japanese Patent Application No. 2014-197301, and Japanese Patent Application No. 2014-197302, all filed on Sep. 26, 2014.

### BACKGROUND

1. Field

The present invention relates to an electrostatic image-developing toner, an electrostatic image developer, and a toner cartridge.

2. Description of the Related Art

A method for visualizing image information, such as electrophotographic method, is utilized in various fields at present. In the electrophotographic method, an electrostatic image is formed as image information on the surface of an image holding member by charging and electrostatic image formation. Thereafter, a toner image is formed on the image holding member surface by using a developer containing a toner, and the toner image is transferred onto a recording medium and then fixed on the recording medium. Through these steps, the image information is visualized as an image.

For example, JP-A-2004-145243 (the term “JP-A” as used herein means an “unexamined published Japanese patent application”) describes “a dry toner where a wax is included as a fine particle in the toner, the wax exists all over the toner from a portion near the surface to the inner part, and the concentration of the wax existing near the surface of the toner is higher than the concentration of the wax existing in the inner part of the toner”. In JP-A-2004-145243, it is disclosed that “in the kneading-pulverization production method, an eccentricity control resin having both a moiety close in polarity to a binder resin and a moiety close in polarity to a release agent is used”.

JP-A-2011-158758 describes “a toner where the wax content is from 3.0 parts by mass to 20.0 parts by mass per 100 parts by mass of a binder resin and the eccentricity degree of a wax in the depth direction of the toner is controlled”. In JP-A-2011-158758, it is disclosed that “with regard to a binder resin and a wax dissolved in a solvent, the wax position is located near the surface by controlling the hydrophilicity/hydrophobicity difference”.

### SUMMARY

<1> An electrostatic image-developing toner containing:

a toner particle containing a binder resin and a release agent and having a sea-island structure involving a sea part containing the binder resin and an island part containing the release agent, in which a mode value of the distribution of the eccentricity degree B represented by the following formula (1) of the release agent-containing island part is from 0.75 to 0.98 and a skewness of the distribution of the eccentricity degree B is from −1.10 to −0.50; and

an external additive containing a silica particle having a volume average particle diameter of 80 nm to 200 nm;

wherein a bulk density of the toner is from 0.33 g/cm³ to 0.40 g/cm³:

Eccentricity degree B=2d/D Formula (1):

in formula (1), D is an equivalent-circle diameter (μm) of the toner particle in the cross-sectional observation of the toner particle, and d is a distance (μm) from the gravity center of the toner particle to the gravity center of the release agent-containing island part in the cross-sectional observation of the toner particle.

### BRIEF DESCRIPTION OF THE DRAWINGS

FIG. 1 is a schematic configuration diagram illustrating an example of the image forming apparatus according to an exemplary embodiment of the present invention.

FIG. 2 is a schematic configuration diagram illustrating an example of the process cartridge according to an exemplary embodiment of the present invention.

FIG. 3 is a schematic view for explaining the power-feed addition method.

FIG. 4 is a diagram illustrating the distribution of the eccentricity degree B of the release agent domain in the toner according to an exemplary embodiment of the present invention.

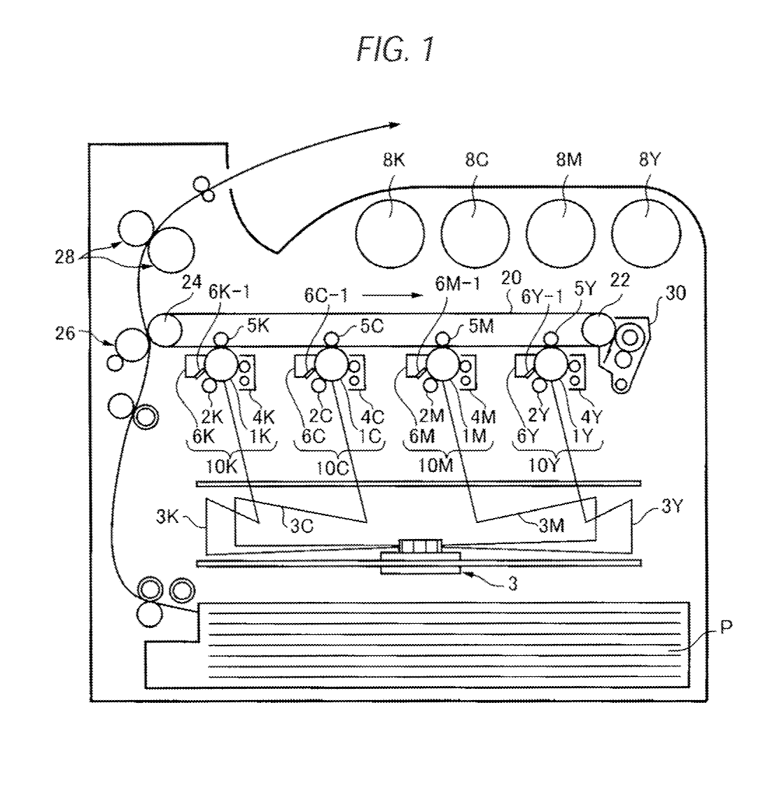

In FIGS. 1Y, 1M, 1C and 1K denote Photoreceptor (one example of the image holding member), 2Y, 2M, 2C and 2K denote Charging roller (one example of the charging unit), 3 denotes Exposure device (one example of the electrostatic image forming unit), 3Y, 3M, 3C and 3K denote Laser beam, 4Y, 4M, 4C and 4K denote Developing device (one example of the developing unit), 5Y, 5M, 5C and 5K denote Primary transfer roller (one example of the primary transfer unit), 6Y, 6M, 6C and 6K denote Photoreceptor cleaning device (one example of the cleaning unit), 6Y-1, 6M-1, 6C-1 and 6K-1 denote Cleaning blade, 8Y, 8M, 8C and 8K denote Toner cartridge, 10Y, 10M, 10C and 10K denote Image forming unit, 20 denotes Intermediate transfer belt (one example of the intermediate transfer material), 22 denotes Drive roller, 24 denotes Support roller, 26 denotes Secondary transfer roller (one example of the secondary transfer unit), 30 denotes Intermediate transfer material cleaning device, 107 denotes Photoreceptor (one example of the image holding member), 108 denotes Charging roller (one example of the charging unit), 109 denotes Exposure device (one example of the electrostatic image forming unit), 111 denotes Developing device (one example of the developing unit), 112 denotes Transfer device (one example of the transfer unit), 113 denotes Photoreceptor cleaning device (one example of the cleaning unit), 113-1: Cleaning blade, 115 denotes Fixing device (one example of the fixing unit), 116 denotes Mounting rail, 118 denotes Opening for exposure, 117 denotes Housing, 200 denotes Process cartridge, 300 denotes Recording paper (one example of the recording medium), P denotes Recording paper (one example of the recording medium).

### DETAILED DESCRIPTION

An exemplary embodiment as an example of the present invention is described in detail below.

### (Electrostatic Image-Developing Toner According to a First Exemplary Embodiment)

The electrostatic image-developing toner (hereinafter referred to as “toner”) according to the first exemplary embodiment of the present invention includes a toner particle containing a binder resin and a release agent, and an external additive containing a silica particle having a volume average particle diameter of 80 nm to 200 nm.

The toner particle has a sea-island structure involving a sea part containing the binder resin and an island part containing the release agent.

In the sea-island structure, a mode value of the distribution of the eccentricity degree B represented by formula (1) of the release agent-containing island part is from 0.75 to 0.98 and the skewness of the distribution of the eccentricity degree B is from −1.10 to −0.50:

Eccentricity degree B=2d/D Formula (1):

in formula (1), D is an equivalent-circle diameter (μm) of the toner particle in the cross-sectional observation of the toner particle, and d is a distance (μm) from the gravity center of the toner particle to the gravity center of the release agent-containing island part in the cross-sectional observation of the toner particle.

A bulk density of the toner is from 0.33 g/cm³ to 0.40 g/cm³.

Thanks to the configuration above, the toner according to the first exemplary embodiment of the present invention suppresses thermal aggregation of the toner and occurrence of a ghost (a phenomenon that a change in the image density is caused due to escape of a silica particle from a cleaning blade) when continuously outputting an image with a high image density at a high speed (for example, when an image with an image density of 20% relative to A4 paper is continuously output on 20,000 sheets at a sheet conveying speed of 100 sheets/min). The reason therefor is not clearly know but is presumed as follows.

In recent years, requirement for image formation (hereinafter, sometimes referred to as “printing”) by an electrophotographic system is increasing on the light printing market such as on-demand printing (a method of printing an image on demand). In this light printing market, printing as not seen in the market of printing within an office or a company (a so-called office printing market) is required. Specifically, one of the requirements is, for example, printing of continuously outputting an image with a high image density at a high speed.

When printing of outputting an image at a high speed is performed, the temperature in the image forming apparatus rises, causing thermal aggregation of a toner. For the purpose of improving thermal storability of the toner and suppressing thermal aggregation of the toner, it is known to externally add a silica particle having a volume average particle diameter of 80 nm to 200 nm (hereinafter, sometimes referred to as “large-diameter silica particle”) to a toner particle.

However, the large-diameter silica particle tends to be unevenly distributed to a concave part on the toner particle surface and may fail in exerting the function of suppressing thermal aggregation of the toner.

On the other hand, it is known to unevenly distribute a release agent to the surface layer part of a toner particle. When a large-diameter silica particle is externally added to a toner particle containing a release agent unevenly distributed to the surface layer part, although the reason is not clearly known, the large-diameter silica particle likely tends to attach in a substantially uniform state to the toner particle surface without undergoing uneven distribution to a concave part on the toner particle surface. Therefore, it becomes easy for the large-diameter silica particle to exert the function of suppressing thermal aggregation of the toner.

However, because of a large particle diameter, the large-diameter silica particle has a property of being readily liberated from a silica particle and when printing of outputting an image with a high image density is performed, a large amount of toner stays in a cleaning part that is a contact part between an image holding member and a cleaning blade, leading to a state where a large amount of a large-diameter silica particle liberated from a toner particle also stays. Therefore, a phenomenon of escape of a large-diameter silica particle from the cleaning blade may occur and in turn, a ghost (a phenomenon that a change in the image density is caused) may be generated.

Here, the eccentricity degree B of the release agent-containing island part (hereinafter, sometimes referred to as “release agent domain”) is an indicator indicating how much distant is the gravity center of the release agent domain from the gravity center of the toner particle. A larger value of the eccentricity degree B indicates that the release agent domain is present near the toner surface, and a smaller value indicates that the release agent domain is present near the center of the toner particle. The mode value of the distribution of the eccentricity degree B indicates a region where a largest number of release agent domains are present in the diameter direction of the toner particle. On the other hand, the skewness of the distribution of the eccentricity degree B indicates a bilateral symmetry of the distribution. Specifically, the skewness of the distribution of the eccentricity degree B indicates the degree of tailing of the distribution from the mode value. That is, the skewness of the distribution of the eccentricity degree B indicates to what extent the release agent domain is distributed in the diameter direction of the toner particle from the region where a largest number of domains are present.

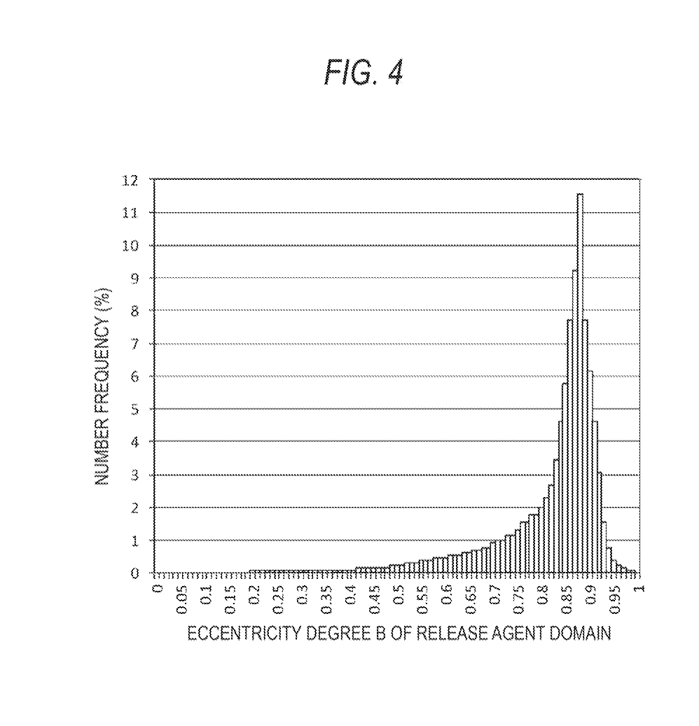

More specifically, when the mode value of the distribution of the eccentricity degree B of the release agent domain is from 0.75 to 0.98, this indicates that a largest number of release agent domains are present in the surface layer part of the toner particle. In addition, when the skewness of the distribution of the eccentricity degree B of the release agent domain is from −1.10 to −0.50, this indicates that the release agent domain is distributed with a gradient from the surface layer part toward the inner part of the toner particle (see, FIG. 4).

In this way, the toner particle in which the mode value and skewness of the distribution of the eccentricity degree B of the release agent domain satisfy the above-described ranges is a toner particle where a largest number of release agent domains are present in the surface layer part and at the same time, the domains are distributed with a gradient from the inner part toward the surface layer part of the toner particle.

When a large-diameter silica particle is externally added to a toner particle having a gradient in the distribution of the release agent domain, since a release agent domain is present in the surface layer part of the toner particle, the large-diameter silica particle likely tends to attach in a substantially uniform state to the toner particle surface without undergoing uneven distributed to a concave part on the toner particle surface. Therefore, it becomes easy for the large-diameter silica particle to exert the function of suppressing thermal aggregation of the toner.

Furthermore, when printing of outputting an image with a high image density is performed and a large amount of the toner stays in the cleaning state, the toner particle is broken due to the pressure in the cleaning part and the release agent domains distributed in the inner part of the toner particle are exposed. The exposed release agent domain exerts the function of taking in a large-diameter silica particle liberated from the toner particle and staying in the cleaning part, whereby escape of a large-diameter silica particle from a cleaning blade is suppressed.

Incidentally, a large-diameter silica particle tends to be embedded in the surface layer of the toner particle due to the pressure in the cleaning part and therefore, it is easy for the release agent domain existing in the surface layer part of the toner particle to exert the function of taking in the large-diameter silica particle liberated.

In addition, when the bulk density of the toner is in the above-described range and the flowability of the toner is thereby increased, this makes it easy for the toner staying in the cleaning part to further intrude into the leading end of the cleaning blade. Then, the toner staying in the cleaning part is likely to receive a stronger pressure, and the toner particle is readily broken. Therefore, a larger number of toner particles are broken, and the release agent domains distributed in the inner part of the toner particle are exposed with ease. As a result, the function of taking in a large-diameter silica particle liberated from the toner particle and staying is more highly exerted.

For these reasons, the toner according to the first exemplary embodiment of the present invention is presumed to suppress thermal aggregation of the toner and occurrence of a ghost when continuously outputting an image with a high image density at a high speed.

In this connection, there are conventionally known, for example, a toner in which the position of a release agent is located near the surface by utilizing the difference in the hydrophilicity/hydrophobicity between a binder resin and a release agent which are dissolved in a solvent (JP-A-2004-145243, etc.), and a toner in which the position of a release agent is located near the surface by a kneading pulverization production method using an eccentricity control resin having both a moiety close in porality to a binder resin and a moiety close in polarity to a release agent (JP-A-2011-158758, etc.). However, in all of these toners, the release agent position within a toner is controlled by physical properties of the material and a gradient cannot be imparted to the distribution of the release agent domain of the toner.

Details of the toner according to the first exemplary embodiment of the present invention are described below.

### (Toner Particle)

The toner particle has a sea-island structure involving a binder resin-containing sea part and a release agent-containing island part. That is, the toner particle has a sea-island structure where a release agent is present like islands in a continuous phase of a binder resin. Incidentally, from the standpoint of reducing the release failure, the release agent domain is preferably not present in the central part (gravity center part) of the toner in the cross-sectional observation of the toner.

In the toner particle having a sea-island structure, the mode value of the distribution of the eccentricity degree B of the release agent domain (release agent-containing island part) is from 0.75 to 0.98 and from the standpoint of suppressing thermal aggregation of the toner and occurrence of a ghost, preferably from 0.80 to 0.95, more preferably from 0.85 to 0.90. Among others, in view of thermal storability of the toner (prevention of thermal aggregation of toner particles), the mode value of the distribution of the eccentricity degree B of the release agent domain is preferably 0.98 or less.

The skewness of the distribution of the eccentricity degree B of the release agent domain (release agent-containing island part) is from −1.10 to −0.50 and from the standpoint of suppressing thermal aggregation of the toner and occurrence of a ghost, preferably from −1.00 to −0.60, more preferably from −0.95 to −0.65.

The method for confirming the sea-island structure of the toner particle is described below.

The sea-island structure of the toner particle is confirmed, for example, by a method of observing the cross-section of a toner particle by a transmission electron microscope, or a method of staining the cross-section of a toner particle with ruthenium tetroxide and observing the cross-section by a scanning electron microscope. From the standpoint that the release agent domain in the cross-section of the toner particle can be more clearly observed, a method of observing the cross-section by a scanning electron microscope is preferred. The scanning electron microscope may be sufficient if it is a model well-known to one skilled in the art, and examples thereof include SU8020 manufactured by Hitachi High-Technologies Corp., and JSM-7500F manufactured by JEOL Ltd.

Specifically, the observation method is as follows. First, a toner particle as the measurement target is embedded in an epoxy resin, and the epoxy resin is cured. The cured product is sectioned by a microtome equipped with a diamond blade to obtain an observation sample in which the cross-section of the toner particle is exposed. Staining with ruthenium tetroxide is applied to the observation sample slice, and the cross-section of the toner particle is observed with a scanning electron microscope. By this observation method, a sea-island structure where due to difference in the staining degree, a release agent having a brightness difference (contrast) is present like islands in a continuous phase of a binder resin, is observed in the cross-section of the toner particle.

The method for measuring the eccentricity degree B of the release agent domain is described below.

The measurement of the eccentricity degree B of the release agent domain is performed as follows. First, an image is recorded at a magnification high enough to capture the cross-section of one toner particle in the visual field. The recorded image is subjected to an image analysis under the condition of 0.010000 μm/pixel by using an image analysis software (WinROOF produced by Mitani Corp.). By this image analysis, the cross-sectional profile of the toner particle is extracted with the aid of brightness difference (contrast) between the epoxy resin used for embedding and the binder resin of the toner particle. The projected area is determined based on the extracted cross-sectional profile of the toner particle, and the equivalent-circle diameter is determined from the projected area. The equivalent-circle diameter is calculated according to the formula: 2√(projected area/π), and the determined equivalent-circle diameter is taken as the equivalent-circle diameter D of the toner particle in the cross-sectional observation of the toner particle.

On the other hand, the gravity center position is determined based on the extracted cross-sectional profile of the toner particle. Subsequently, the shape of the release agent domain is extracted with the aid of brightness difference (contrast) between the binder resin and the release agent, and the gravity center position of the release agent domain is determined. Specifically, each of these gravity center positions is determined as a value obtained by assuming that with respect to the extracted region of the toner particle or release agent domain, the number of pixels in the region is n and the xy-coordinates of each pixel are xᵢ and yᵢ (i=1, 2, . . . , n), and dividing the total of respective xᵢ coordinate values by n for the x-coordinate of the gravity center or dividing the total of respective yᵢ coordinate values by n for the y-coordinate of the gravity center. The distance between the gravity center position of the cross-section of the toner particle and the gravity center position of the release agent domain is then determined, and the determined distance is taken as the distance d from the gravity center of the toner particle to the gravity center of the release agent-containing island part in the cross-sectional observation of the toner particle.

Finally, from the equivalent-circle diameter D and the distance d, the eccentricity degree B of the release agent domain is determined according to formula (1): eccentricity degree B=2d/D. The same operation as above is performed on each of a plurality of release agent domains present in the cross-section of one toner particle, whereby the eccentricity degree B of the release agent domain is determined.

The method for calculating the mode value of the distribution of the eccentricity degree B of the release agent domain is described below.

First, the above-described measurement of the eccentricity degree B of the release agent domain is performed on 200 toner particles. Using the obtained data on the eccentricity degree B of respective release agent domains, statistical and analytical processing is performed for data segments in steps of 0.01 from 0 to determine the distribution of the eccentricity degree B, and the mode value of the obtained distribution, that is, the value of the data segment appearing most frequently in the distribution of the eccentricity degree B of the release agent domain, is determined. The value of this data segment is taken as the mode value of the distribution of the eccentricity degree B of the release agent domain.

The method for calculating the skewness of the distribution of the eccentricity degree B of the release agent domain is described below.

First, the distribution of the eccentricity degree B of the release agent domain is determined as described above. The skewness of the distribution of the eccentricity degree B is determined based on the obtained distribution according to the following formula. In the following formula, the skewness is Sk, the number of data on the eccentricity degree B of the release agent domain is n, the value of data on the eccentricity degree B of each release agent domain is xᵢ (i=1, 2, . . . , n), the average value of the entire data on the eccentricity degree B of the release agent domain is x (x with a bar at the top), and the standard deviation of the entire data on the eccentricity degree B of the release agent domain is s.

$$Sk = \frac{n}{( n - 1 ) ( n - 2 )} {\sum }_{i = 1}^{n} {( \frac{{x}_{i} - \overline{x}}{s} )}^{3}$$

The method for satisfying the distribution characteristics of the eccentricity degree B of the release agent domain in the toner particle is described in Production Method of Toner.

The bulk density of the toner is from 0.33 g/cm³ to 0.40 g/cm³ and from the standpoint of suppressing thermal aggregation of the toner and occurrence of a ghost, preferably from 0.34 g/cm³ to 0.39 g/cm³, more preferably from 0.35 g/cm³ to 0.38 g/cm³.

The bulk density of the toner is controlled, for example, by the particle diameter, externally added amount or external addition conditions of the large-diameter silica particle.

The bulk density of the toner is a value measured by the following method.

A 106 μm-mesh net is placed on a funnel, 100 g of the toner is charged into a cylindrical vessel having an internal volume of about 25 ml and an inner diameter of about 30 mm, and the weight before and after the charging is measured, whereby the bulk density of the toner is measured.

The constituent components of the toner particle are described below.

The toner particle contains a binder resin and a release agent. Specifically, the toner particle has a toner particle containing a binder resin and a release agent. The toner particle may contain other additives such as coloring agent.

### —Binder Resin—

The binder resin includes, for example, a vinyl-based resin composed of a homopolymer of a monomer such as styrenes (e.g., styrene, p-chlorostyrene, α-methylstyrene), (meth)acrylic acid esters (e.g., methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate), ethylenically unsaturated nitriles (e.g., acrylonitrile, methacrylonitrile), vinyl ethers (e.g., vinyl methyl ether, vinyl isobutyl ether), vinyl ketones (e.g., vinyl methyl ketone, vinyl ethyl ketone, vinyl isopropenyl ketone) and olefins (e.g., ethylene, propylene, butadiene), or a copolymer using two or more of these monomers in combination.

The binder resin includes, for example, a non-vinyl-based resin such as epoxy resin, polyester resin, polyurethane resin, polyamide resin, cellulose resin, polyether resin and modified rosin, a mixture thereof with the above-described vinyl-based resin, and a graft polymer obtained by polymerizing a vinyl-based monomer in the presence of the resin above.

One of these binder resins may be used alone, or two or more thereof may be used in combination.

A polyester resin is suitable as the binder resin.

The polyester resin includes, for example, known polyester resins.

The polyester resin includes, for example, a condensation polymer of a polyvalent carboxylic acid and a polyhydric alcohol. As for the polyester resin, a commercially available product may be used, or a resin synthesized may be used.

The polyvalent carboxylic acid includes, for example, an aliphatic dicarboxylic acid (e.g., oxalic acid, malonic acid, maleic acid, fumaric acid, citraconic acid, itaconic acid, glutaconic acid, succinic acid, alkenyl succinic acid, adipic acid, sebacic acid), an alicyclic dicarboxylic acid (e.g., cyclohexanedicarboxylic acid), an aromatic dicarboxylic acid (e.g., terephthalic acid, isophthalic acid, phthalic acid, naphthalenedicarboxylic acid), an anhydride thereof, and a lower alkyl ester (for example, having a carbon number of 1 to 5) thereof. Among these, the polyvalent carboxylic acid is preferably, for example, an aromatic dicarboxylic acid.

As the polyvalent carboxylic acid, a trivalent or higher valent carboxylic acid forming a crosslinked structure or a branched structure may be used in combination, together with a dicarboxylic acid. The trivalent or higher valent carboxylic acid includes, for example, trimellitic acid, pyromellitic acid, an anhydride thereof, and a lower alkyl ester (for example, having a carbon number of 1 to 5) thereof.

One of these polyvalent carboxylic acids may be used alone, or two or more thereof may be used in combination.

The polyhydric alcohol includes, for example, an aliphatic diol (e.g., ethylene glycol, diethylene glycol, triethylene glycol, propylene glycol, butanediol, hexanediol, neopentyl glycol), an alicyclic diol (e.g., cyclohexanediol, cyclohexanedimethanol, hydrogenated bisphenol A), and an aromatic diol (e.g., an ethylene oxide adduct of bisphenol A, a propylene oxide adduct of bisphenol A). Among these, the polyhydric alcohol is preferably, for example, an aromatic diol or an alicyclic diol, more preferably an aromatic diol.

As the polyhydric alcohol, a trivalent or higher valent polyhydric alcohol forming a crosslinked structure or a branched structure may be used in combination together with the diol. The trivalent or higher valent polyhydric alcohol includes, for example, glycerin, trimethylolpropane, and pentaerythritol.

One of these polyhydric alcohols may be used alone, or two or more thereof may be used in combination.

The glass transition temperature (Tg) of the polyester resin is preferably from 50° C. to 80° C., more preferably from 50° C. to 65° C.

Incidentally, the glass transition temperature is determined from a DSC curve obtained by differential scanning calorimetry (DSC), more specifically, is determined as the “extrapolated glass transition initiation temperature” described in the determination method of glass transition temperature of JIS K-1987, “Method for Measuring Transition Temperature of Plastics”.

The weight average molecular weight (Mw) of the polyester resin is preferably from 5,000 to 1,000,000, more preferably from 7,000 to 500,000.

The number average molecular weight (Mn) of the polyester resin is preferably from 2,000 to 100,000.

The molecular weight distribution Mw/Mn of the polyester resin is preferably from 1.5 to 100, more preferably from 2 to 60.

The weigh average molecular weight and number average molecular weight are measured by gel permeation chromatography (GPC). The measurement of the molecular weight by GPC is performed with a THF solvent by using, as the measuring apparatus, GPC, HLC-8120GPC, manufactured by Tosoh Corporation and using a column, TSKgel Super HM-M (15 cm), manufactured by Tosoh Corporation. The weight average molecular weight and number average molecular weight are calculated from the measurement results by using a molecular weight calibration curve prepared from a monodisperse polystyrene standard sample.

The polyester resin is obtained by a known production method. Specifically, the polyester resin is obtained, for example, by a method where the polymerization temperature is set to be from 180° C. to 230° C. and after reducing, if desired, the pressure in the reaction system, the reaction is performed while removing water or alcohol occurring at the time of condensation.

Incidentally, in the case where a raw material monomer is insoluble or incompatible at the reaction temperature, the monomer may be dissolved by adding a high-boiling-point solvent as a dissolution aid. In this case, the polycondensation reaction is performed while distilling out the dissolution aid. In the copolymerization reaction, when a monomer with poor compatibility is present, the poorly compatible monomer may be previously condensed with an acid or alcohol to be polycondensed with the monomer, and then polycondensed together with the main component.

The content of the binder resin is, for example, preferably from 40 mass % to 95 mass %, more preferably from 50 mass % to 90 mass %, still more preferably from 60 mass % to 85 mass %, based on the entire toner particle.

### —Release Agent—

The release agent includes, for example, a hydrocarbon-based wax; a natural wax such as carnauba wax, rice wax and candelilla wax; a synthetic or mineraUpetroleum wax such as montan wax; and an ester-based wax such as fatty acid ester and montanic acid ester. The release agent is not limited thereto.

Among these, a hydrocarbon-based wax (a wax having a hydrocarbon as the framework) is preferred as the release agent. The hydrocarbon-based wax is advantageous in that it readily forms a release agent domain and is likely to rapidly bleed out to the toner particle surface at the time of fixing.

The content of the release agent is, for example, preferably from 1 mass % to 20 mass %, more preferably from 5 mass % to 15 mass %, based on the entire toner particle.

### —Coloring Agent—

The coloring agent includes, for examples, various pigments such as carbon black, Chrome Yellow, Hansa Yellow, Benzidine Yellow, Threne Yellow, Quinoline Yellow, Pigment Yellow, Permanent Orange GTR, Pyrazolone Orange, Vulcan Orange, Watchung Red, Permanent Red, Brilliant Carmine 3B, Brilliant Carmine 6B, DuPont Oil Red, Pyrazolone Red, Lithol Red, Rhodamine B Lake, Lake Red C, Pigment Red, Rose Bengal, Aniline Blue, Ultramarine Blue, Calco Oil Blue, Methylene Blue Chloride, Phthalocyanine Blue, Pigment Blue, Phthalocyanine Green and Malachite Green Oxalate; and various dyes such as acridine type, xanthene type, azo type, benzoquinone type, azine type, anthraquinone type, thioindigo type, dioxazine type, thiazine type, azomethine type, indigo type, phthalocyanine type, aniline black type, polymethine type, triphenylmethane type, diphenylmethane type and thiazole type.

One of these coloring agents may be used alone, or two or more thereof may be used in combination.

As for the coloring agent, a surface-treated coloring agent may be used, if desired, or the coloring agent may be used in combination with a dispersant. In addition, a plurality of kinds of coloring agents may be used in combination.

The content of the coloring agent is, for example, preferably from 1 mass % to 30 mass %, more preferably from 3 mass % to 15 mass %, based on the entire toner particle.

### —Other Additives—

Other additives include, for example, known additives such as magnetic material, charge controlling agent and inorganic powder. These additives are contained as an internal additive in the toner particle.

—Properties, Etc. Of Toner Particle—

The toner particle may be a toner particle having a single layer structure or may be a toner particle having a so-called core/shell structure consisting of a core part (core particle) and a coating layer (shell layer) covering the core part.

Here, the toner particle having a core/shell structure preferably consists of, for example, a core part configured to contain a binder resin, a release agent and, if desired, other additives such as coloring agent, and a coating layer configured to contain a binder resin.

The volume average particle diameter (D50v) of the toner particle is preferably from 2 μm to 10 μm, more preferably from 4 μm to 8 μm.

Incidentally, various average particle diameters and various particle size distribution indices of the toner particle are measured by means of Coulter Multisizer-II (manufactured by Beckman Coulter Co.) by using ISOTON-II (produced by Beckman Coulter Co.) as the electrolytic solution.

In the measurement, from 0.5 mg to 50 mg of a measurement sample is added to 2 ml of a 5% aqueous solution of a surfactant (sodium alkylbenzenesulfonate) as a dispersant, and the resulting solution is added to from 100 ml to 150 ml of the electrolytic solution.

The electrolytic solution having suspended therein the measurement sample is subjected to a dispersion treatment for 1 minute in an ultrasonic dispersing machine, and the particle size distribution of particles having a particle diameter of 2 μm to 60 μm is measured by Coulter Multisizer-II using an aperture having an aperture diameter of 100 μm. The number of particles sampled is 50,000.

A cumulative distribution of each of volume and number is drawn from the small diameter side for divided particle size ranges (channels) based on the particle size distribution measured. The particle diameters at an accumulation of 16% are defined as volume particle diameter D16v and number particle diameter D16p, the particle diameters at an accumulation of 50% are defined as volume average particle diameter D50v and cumulative number average particle diameter D50p, and the particle diameters at an accumulation of 84% are defined as volume particle diameter D84v and number particle diameter D84p.

Using these values, the volume average particle size distribution index (GSDv) is calculated as (D84v/D16v)^{1/2}, and the number average particle size distribution index (GSDp) is calculated as (D84p/D16p)¹¹².

The shape factor SF1 of the toner particle is preferably from 110 to 150, more preferably from 120 to 140.

The shape factor SF1 is determined by the following formula:

SF1=(ML²/A)×(π/4)×100 Formula:

In the formula above, ML represents the absolute maximum length of the toner, and A represents the projected area of the toner.

Specifically, mainly a microscope image or scanning electron microscope (SEM) image is numerically expressed by the analysis using an image analyzer and used for calculation as follows. That is, an optical microscope image of particles scattered on a slide glass surface is taken into a Luzex image analyzer through a video camera, the maximum length and projected area are measured on 100 particles, and after calculation according to the formula above, the average value is determined, whereby the shape factor SF1 is obtained.

### (External Additive)

The external additive contains a large-diameter silica particle. The large-diameter silica particle may be sufficient if it is a particle using silica, i.e., SiO₂, as the main component, and may be crystalline or amorphous. Also, the silica particle may be a particle produced using, as a raw material, a silicon compound such as water glass and alkoxysilane or may be a particle obtained by pulverizing quartz.

Specifically, the large-diameter silica particle includes, for example, a sol-gel silica particle, an aqueous colloidal silica particle, an alcoholic silica particle, a fumed silica particle obtained by a gas phase process, and a fused silica particle.

The volume average particle diameter of the large-diameter silica particle is from 80 inn to 200 nm and from the standpoint of suppressing thermal aggregation of the toner and occurrence of a ghost, preferably from 90 nm to 170 nm, more preferably from 100 nm to 140 nm.

The volume average particle diameter of the large-diameter silica particle is a value measured by the following method.

First, 100 primary particles of the large-diameter silica particle are observed by SEM (Scanning Electron Microscope). Then, the longest diameter and the shortest diameter of each particle are measured by image analysis of the primary particle, and the equivalent-sphere diameter is measured from the median value therebetween. The 50% diameter (D50v) in a cumulative frequency on the volume basis of the obtained equivalent-sphere diameter is defined as the volume average particle diameter of the large-diameter silica particle.

The large-diameter silica particle may be subjected to a hydrophobizing treatment. The hydrophobizing treatment is performed, for example, by immersing the large-diameter silica particle in a hydrophobizing agent. The hydrophobizing agent includes, for example, a silane coupling agent and silicone oil.

The silane coupling agent includes, for example, hexamethyldisilazane, trimethylsilane, trimethylchlorosilane, dimethyldichlorosilane, methyltrichlorosilane, allyldimethylchlorosilane, benzyldimethylchlorosilane, methyltrimethoxysilane, methyltriethoxysilane, isobutyltrimethoxysilane, dimethyldimethoxysilane, dimethyldiethoxysilane, trimethylmethoxysilane, hydroxypropyltrimethoxysilane, phenyltrimethoxysilane, n-butyltrimethoxysilane, n-hexadecyltrimethoxysilane, n-octadecyltrimethoxysilane, vinyltrimethoxysilane, vinyltriethoxysilane, γ-methacryloxypropyltrimethoxysilane, and vinyltriacetoxysilane.

The silicone oil includes, for example, dimethylpolysiloxane, methylhydrozinepolysiloxane, and methylphenylpolysiloxane.

In addition, the hydrophobizing agent also includes known hydrophobizing agents such as titanate coupling agent and aluminum coupling agent.

One hydrophobizing agent may be used alone, or two or more hydrophobizing agents may be used in combination.

The externally added amount (amount added) of the large-diameter silica particle is preferably from 1.0 mass % to 4.0 mass %, more preferably from 1.2 mass % to 3.2 mass %, still more preferably from 1.4 mass % to 2.5 mass %, based on the total mass of the toner particle.

As the external additive, external additives other than the large-diameter silica particle may also be applied.

Other external additives include, for example, an inorganic particle (an inorganic particle except for the large-diameter silica particle) such as silica, alumina, titania, barium titanate, magnesium titanate, calcium titanate, strontium titanate, zinc oxide, quartz sand, clay, mica, wollastonite, diatomaceous earth, chromium oxide, cerium oxide, red iron oxide, antimony trioxide, magnesium oxide, zirconium oxide, barium sulfate, barium carbonate, calcium carbonate, silicon carbide and silicon nitride. In addition, other external additives also include a resin particle such as fluororesin and silicone resin, and a particle of a metal salt of a higher fatty acid typified by zinc stearate.

The surface of the inorganic particle as other additives is preferably subjected to a hydrophobizing treatment. The hydrophobizing treatment is performed, for example, by immersing the inorganic particle in a hydrophobizing agent. The hydrophobizing agent is not particularly limited but includes, for example, a silane coupling agent, silicone oil, a titanate coupling agent, and an aluminum coupling agent. One of these compounds may be used alone, or two or more thereof may be used in combination.

The externally added amount (amount added) of the other external additive is, for example, preferably from 0.01 mass % to 5 mass %, more preferably from 0.01 mass % to 2.0 mass %, based on the total mass of the toner particle.

### (Production Method of Toner)

The method for producing the toner according to the first exemplary embodiment of the present invention is described below.

The toner according to the first exemplary embodiment of the present invention is obtained by externally adding an external additive to a toner particle after the production of the toner particle.

The toner particle may be produced by either a dry production method (for example, a kneading-pulverization method) or a wet production method (for example, an aggregation-coalescence method, a suspension polymerization method, and a dissolution-suspension method). The production method of the toner particle is not particularly limited to these production methods, and a known production method is employed.

Among others, the toner particle is preferably obtained by an aggregation-coalescence method.

In particular, from the standpoint of obtaining a toner (toner particle) satisfying the above-described distribution characteristics of the eccentricity degree B of the release agent domain, the toner particle is preferably produced by the aggregation-coalescence method described below. In the following aggregation-coalescence method, a method for producing a toner (toner particle) also containing a coloring agent is described, but the coloring agent is an additive incorporated into the toner particle, if desired.

Specifically, the toner particle is preferably produced through:

a step of preparing each dispersion liquid (dispersion liquid preparing step),

a step of mixing a first resin particle dispersion liquid having dispersed therein a first resin particle working out to a binder resin and a coloring agent particle dispersion liquid having dispersed therein a particle of a coloring agent (hereinafter, sometimes referred to as “coloring agent particle”) and aggregating respective particles in the obtained dispersion liquid to form a first aggregate particle (first aggregate particle forming step),

a step of, after obtaining a first aggregate particle dispersion liquid having dispersed therein the first aggregate particle, sequentially adding a mixed dispersion liquid having dispersed therein a second resin particle working out to a binder resin and a particle of a release agent (hereinafter sometimes referred to as “release agent particle”) to the first aggregate particle dispersion liquid while gradually increasing the concentration of the release agent particle in the mixed dispersion liquid, and further aggregating the second resin particle and the release agent particle on the surface of the first aggregate particle to form a second aggregate particle (second aggregate particle forming step),

a step of, after obtaining a second aggregate particle dispersion liquid having dispersed therein the second aggregate particle, further mixing the second aggregate particle dispersion liquid and a third resin particle dispersion liquid having dispersed therein a third resin particle working out to a binder resin and aggregating the third resin particle in the manner of further attaching to the surface of the second aggregate particle to form a third aggregate particle (third aggregate particle forming step), and

a step of heating a third aggregate particle dispersion liquid having dispersed therein the third aggregate particle, thereby fusing/coalescing third aggregate particles to form a toner particle (fusion/coalescence step).

The production method of the toner particle is not limited to the method above. For example, the toner particle may also be formed by mixing a resin particle dispersion liquid and a coloring agent particle dispersion liquid; aggregating respective particles in the mixed dispersion liquid obtained; adding a release agent particle dispersion liquid to the mixed dispersion liquid in the course of aggregation while gradually increasing the addition rate or increasing the concentration of the release agent particle, thereby allowing aggregation of respective particles to proceed and forming an aggregate particle; and fusing/coalescing the aggregate particles.

Respective steps are described in detail below.

### —Each Dispersion Liquid Preparing Step—

First, each dispersion liquid for use in the aggregation-coalescence method is prepared. Specifically, a first resin particle dispersion liquid having dispersed therein a first resin particle working out to a binder resin, a coloring agent particle dispersion liquid having dispersed therein a coloring agent particle, a second resin particle dispersion liquid having dispersed therein a second resin particle working out to a binder resin, a third resin particle dispersion liquid having dispersed therein a third resin particle working out to a binder resin, and a release agent particle dispersion liquid having dispersed therein a release agent particle are prepared.

In the description of each dispersion liquid preparing step, the first resin particle, the second resin particle and the third resin particle are referred to as “resin particle”.

Here, the resin particle dispersion liquid is prepared, for example, by dispersing a resin particle in a dispersion medium with the aid of a surfactant.

The dispersion medium for use in the resin particle dispersion liquid includes, for example, an aqueous medium.

The aqueous medium includes, for example, water such as distilled water and ion-exchanged water, and alcohols. One of these mediums may be used alone, or two or more thereof may be used in combination.

The surfactant includes, for example, an anionic surfactant such as sulfuric ester salt type, sulfonate type, phosphoric ester type and soap type; a cationic surfactant such as amine salt type and quaternary ammonium salt type; and a nonionic surfactant such as polyethylene glycol type, alkyl phenol ethylene oxide adduct type and polyhydric alcohol type. Among these, an anionic surfactant or a cationic surfactant are used in particular. A nonionic surfactant may be used in combination with an anionic surfactant or a cationic surfactant.

One of these surfactants may be used alone, or two or more thereof may be used in combination.

In the resin particle dispersion liquid, the method for dispersing the resin particle in a dispersion medium includes, for example, a rotation shearing homogenizer and a general dispersion method using media, such as ball mill, sand mill and dynomill. Also, depending on the kind of the resin particle, the resin particle may be dispersed in the resin particle dispersion liquid by using, for example, a phase inversion emulsification method.

Incidentally, the phase inversion emulsification method is a method of dissolving a resin to be dispersed, in a hydrophobic organic solvent in which the resin is soluble, adding a base to a continuous organic phase (O phase) to cause neutralization, and then charging an aqueous medium (W phase) to invert the resin from W/O to O/W (so-called phase inversion) and form a discontinuous phase, thereby dispersing the resin as particles in the aqueous medium.

The volume average particle diameter of the resin particle dispersed in the resin particle dispersion liquid is, for example, preferably from 0.01 μm to 1 μm, more preferably from 0.08 μm to 0.8 μm, still more preferably from 0.1 μm to 0.6 μm.

The volume average particle diameter of the resin particle is determined by drawing a cumulative volume distribution from the small diameter side for divided particle size ranges (channels) based on a particle size distribution obtained by measurement with a laser diffraction particle size distribution meter (for example, LA-700, manufactured by Horiba, Ltd.) and taking the particle diameter at an accumulation of 50% relative to all particles as the volume average particle diameter D50v. Incidentally, the volume average particle diameter of particles in other dispersion liquids is measured in the same manner.

The content of the resin particle in the resin particle dispersion liquid is, for example, preferably from 5 mass % to 50 mass %, more preferably from 10 mass % to 40 mass %.

For example, a coloring agent particle dispersion liquid and a release agent particle dispersion liquid are also prepared in the same manner as the resin particle dispersion liquid. That is, with regard to the volume average particle diameter of particles, dispersion medium, dispersion method and particle content in the resin particle dispersion, the same applies to the coloring agent particle dispersed in the coloring agent particle dispersion liquid and the release agent particle dispersed in the release agent particle dispersion liquid.

### —First Aggregate Particle Forming Step—

Next, the first resin particle dispersion liquid and the coloring agent particle dispersion liquid are mixed.

In the mixed dispersion liquid, a first resin particle and a coloring agent particle are hetero-aggregated to form a first aggregate particle containing a first resin particle and a coloring agent particle.

Specifically, for example, a coagulant is added to the mixed dispersion liquid and at the same time, the pH of the mixed dispersion liquid is adjusted to acidic (for example, a pH of 2 to 5). After adding, if desired, a dispersion stabilizer, the mixed dispersion liquid is heated at a temperature corresponding to the glass transition temperature of the first resin particle (specifically, for example, from glass transition temperature of first resin particle −30° C. to glass transition temperature −10° C.) to aggregate particles dispersed in the mixed dispersion liquid and form a first aggregate particle.

In the first aggregate particle forming step, the coagulant above may be added at room temperature (for example, 25° C.) while stirring the mixed dispersion liquid by a rotation shearing homogenizer and after adjusting the pH of the mixed dispersion liquid to acidic (for example, a pH of 2 to 5) and adding, if desired, a dispersion stabilizer, the above-described heating may be performed.

The coagulant includes, for example, a surfactant having a polarity opposite the polarity of the surfactant used as a dispersant added to the mixed dispersion liquid, an inorganic metal salt, and a divalent or higher valent metal complex. In particular, when a metal complex is used as the coagulant, the amount of the surfactant used is decreased, and the charging characteristics are enhanced.

An additive forming a complex or similar bond with a metal ion of the coagulant may be used, if desired. As this additive, a chelating agent is suitably used.

The inorganic metal salt includes, for example, a metal salt such as calcium chloride, calcium nitrate, barium chloride, magnesium chloride, zinc chloride, aluminum chloride and aluminum sulfate, and an inorganic metal salt polymer such as polyaluminum chloride, polyaluminum hydroxide and calcium polysulfide.

As the chelating agent, a water-soluble chelating agent may also be used. The chelating agent includes, for example, an oxycarboxylic acid such as tartaric acid, citric acid and gluconic acid, an iminodiacetic acid (IDA), a nitrilotriacetic acid (NTA), and an ethylenediaminetetraacetic acid (EDTA).

The amount of the chelating agent added is, for example, preferably from 0.01 parts by mass to 5.0 parts by mass, more preferably from 0.1 parts by mass to less than 3.0 parts by mass, per 100 parts by mass of the first resin particle.

### —Second Aggregate Particle Forming Step—

After obtaining a first aggregate particle dispersion liquid having dispersed therein the first aggregate particle, a mixed dispersion liquid having dispersed therein a second resin particle and a release agent particle is sequentially added to the first aggregate particle dispersion liquid while gradually increasing the concentration of the release agent particle in the mixed dispersion liquid.

The kind of the second resin particle may be the same as or different from the first resin particle.

Thereafter, the second resin particle and the release agent particle are aggregated on the surface of the first aggregate particle in the dispersion liquid having dispersed therein the first aggregate particle, the second resin particle and the release agent particle. Specifically, for example, when the first aggregate particle reaches the target particle diameter in the first aggregate particle forming step, a mixed dispersion liquid having dispersed therein a second resin particle and a release agent particle is added to the first aggregate particle dispersion liquid while increasing the concentration of the release agent particle, and the resulting dispersion liquid is heated at a temperature not higher than the glass transition temperature of the second resin particle.

Through this step, an aggregate particle in which a second resin particle and a release agent particle are attached to the surface of a first aggregate particle, is formed. That is, a second aggregate particle in which an aggregate of a second resin particle and a release agent particle is attached to the surface of a first aggregate particle, is formed. At this time, since a mixed dispersion liquid having dispersed therein a second resin particle and a release agent particle is sequentially added to the first aggregate particle dispersion liquid while gradually increasing the concentration of the release agent particle in the mixed dispersion liquid, an aggregate of a second resin particle and a release agent particle is attached to the surface of the first aggregate particle with a gradual increase in the concentration (abundance) of the release agent particle toward the outer side in the particle diameter direction.

As the method for adding the mixed dispersion liquid, a power-feed addition method is preferably utilized. By utilizing the power-feed addition method, the mixed dispersion liquid can be added to the first aggregate particle dispersion liquid while gradually increasing the concentration of the release agent particle in the mixed dispersion liquid.

The method for adding the mixed dispersion liquid by utilizing the power-feed addition method is described below by referring to the drawing.

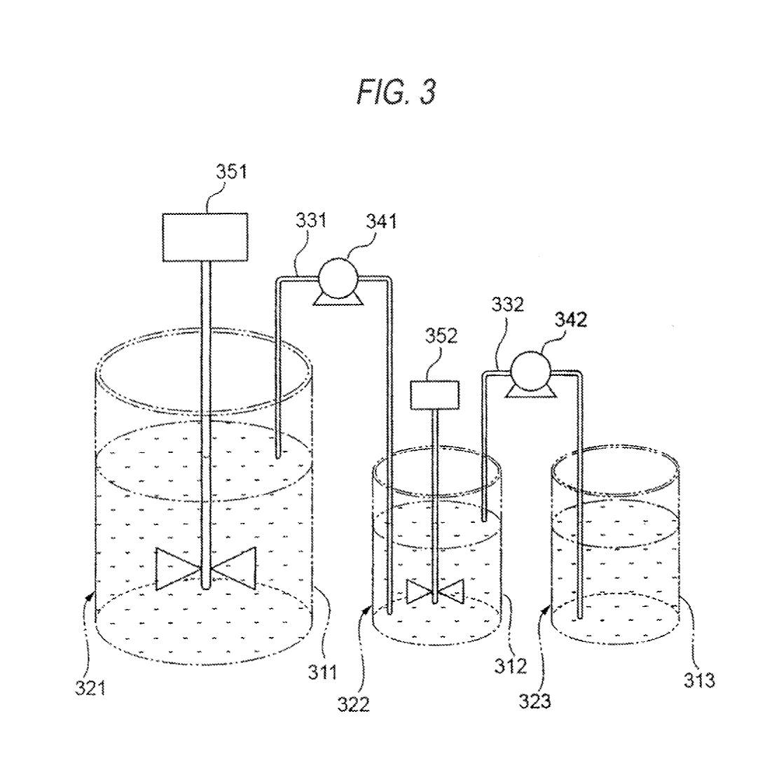

FIG. 3 depicts an apparatus used for the power-feed addition method. In FIG. 3, 311 indicates a first aggregate particle dispersion liquid, 312 indicates a second resin particle dispersion liquid, and 313 indicates a release agent particle dispersion liquid.

The apparatus depicted in FIG. 3 has a first storage tank 321 storing a first aggregate particle dispersion liquid having dispersed therein a first aggregate particle, a second storage tank 322 storing a second resin particle dispersion liquid having dispersed therein a second resin particle, and a third storage tank 323 storing a release agent particle dispersion liquid having dispersed therein a release agent particle.

The first storage tank 321 and the second storage tank 322 are connected by a first liquid feed pipe 331. A first liquid feed pump 341 intervenes in the middle of the route of the first liquid feed pipe 331. The dispersion liquid stored in the second storage tank 322 is fed to the dispersion liquid stored in the first storage tank 321 through the first liquid feed pipe 331 by the drive of the first liquid feed pump 341.

A first stirring device 351 is disposed in the first storage tank 321. When the dispersion liquid stored in the second storage tank 322 is fed to the dispersion liquid stored in the first storage tank 321, respective dispersion liquids are stirred and mixed in the first storage tank 321 by the drive of the first stirring device 351.

The second storage tank 322 and the third storage tank 323 are connected by a second liquid feed pipe 332. A second liquid feed pump 342 intervenes in the middle of the route of the second liquid feed pipe 332. The dispersion liquid stored in the third storage tank 323 is fed to the dispersion liquid stored in the second storage tank 322 through the second liquid feed pipe 332 by the drive of the second liquid feed pump 342.

A second stirring device 352 is disposed in the second storage tank 322. When the dispersion liquid stored in the third storage tank 323 is fed to the dispersion liquid stored in the second storage tank 322, respective dispersion liquids are stirred and mixed in the second storage tank 322 by the drive of the second stirring device 352.

In the apparatus depicted in FIG. 3, first, a first aggregate particle forming step is carried out in the first storage tank 321 to prepare a first aggregate particle dispersion liquid, and the first aggregate particle dispersion liquid is stored in the first storage tank 321. Incidentally, it may be also possible that the first aggregate particle forming step is performed in another thank to prepare a first aggregate particle dispersion liquid and the first aggregate particle dispersion liquid is then stored in the first storage tank 321.

In this state, the first liquid feed pump 341 and the second liquid feed pump 342 are driven. By the drive of these pumps, the second resin particle dispersion liquid stored in the second storage tank 322 is fed to the first aggregate particle dispersion liquid stored in the first storage tank 321. Respective dispersion liquids are stirred and mixed in the first storage tank 321 by the drive of the first stirring device 351.

On the other hand, the release agent particle dispersion liquid stored in the third storage tank 323 is fed to the second resin particle dispersion liquid stored in the second storage tank 322, and respective dispersion liquids are stirred and mixed in the second storage tank 322 by the drive of the second stirring device 352.

At this time, the release agent particle dispersion liquid is sequentially fed to the second resin particle dispersion liquid stored in the second storage tank 322, and the concentration of the release agent particle is gradually increased. In consequence, a mixed dispersion liquid having dispersed therein a second resin particle and a release agent particle is stored in the second storage tank 322, and the mixed dispersion liquid is fed to the first aggregate particle dispersion liquid stored in the first storage tank 321. This feed of the mixed dispersion liquid is continuously performed while causing an increase in the concentration of the release agent particle dispersion liquid in the mixed dispersion liquid.

In this way, by utilizing the power-feed addition method, the mixed dispersion liquid having dispersed therein a second resin particle and a release agent particle can be added to the first aggregate particle dispersion liquid while gradually increasing the concentration of the release agent particle.

In the power-feed addition method, the distribution characteristics of the release agent domain of the toner are controlled by adjusting the timing for starting the feed and the feed rate of respective dispersion liquids stored in the second storage tank 322 and the third storage tank 323. In the power-feed addition method, the distribution characteristics of the release agent domain of the toner are controlled also by adjusting the feed rate during the feed of respective dispersion liquids stored in the second storage tank 322 and the third storage tank 323.

Specifically, for example, the mode value of the distribution of the eccentricity degree B of the release agent domain is adjusted by the timing for ending the feed of the release agent particle dispersion liquid from the third storage tank 323 to the second storage tank 322. More specifically, for example, when the feed of the release agent particle dispersion liquid from the third storage tank 323 to the second storage tank 322 is ended before the feed from the second storage tank 322 to the first storage thank 321 is ended, the concentration of the release agent particle in the mixed dispersion liquid in the second storage tank 322 is not increased any more after that. In turn, the mode value of the distribution of the eccentricity degree B of the release agent domain becomes small.

In addition, for example, the skewness of the distribution of the eccentricity degree B of the release agent domain is controlled by the timing for feeding respective dispersion liquids from the second storage tank 322 and the third storage tank 323 as well as by the feed rate when feeding the dispersion liquid from the second storage tank 322 to the first storage tank 321. More specifically, for example, when the timing for starting the feed of the release agent particle dispersion liquid from the third storage tank 323 and the timing for starting the feed of the dispersion liquid from the second storage tank 322 are expedited and the feed rate of the dispersion liquid from the second storage tank 322 is decreased, the aggregate particle formed is put into the state that a release agent particle is disposed over a region from the deeper side to the outer side of the particle, as a result, the skewness of the distribution of the eccentricity degree B of the release agent domain becomes large.

The power-feed addition method is not limited to the above-described technique, and there may be employed various methods, for example, 1) a method where a storage tank storing the second resin particle dispersion liquid and a storage tank storing a mixed dispersion liquid having dispersed therein dispersion liquids of a second resin particle and a release agent particle are additionally provided and these dispersion liquids are fed to the first storage tank 321 from respective storage tanks while changing the feed rate, and a method where a storage tank storing the release agent particle dispersion liquid and a storage tank storing a mixed dispersion liquid having dispersed therein dispersion liquids of a second resin particle and a release agent particle are additionally provided and these dispersion liquids are fed to the first storage tank 321 from respective storage tanks while changing the feed rate.

By the operation above, a second aggregate particle in which a second resin particle and a release agent particle are aggregated in the manner of attaching to the surface of a first aggregate particle is obtained.

### —Third Aggregate Particle Forming Step—

After obtaining the second aggregate particle dispersion liquid having dispersed therein a second aggregate particle, the second aggregate particle dispersion liquid and a third resin particle dispersion liquid having dispersed therein a third resin particle working out to a binder resin are further mixed.

The kind of the third resin particle may be the same as or different from the first or second resin particle.

In the dispersion liquid having dispersed therein a second aggregate particle and a third resin particle, the third resin particle is aggregated on the surface of the second aggregate particle. Specifically, for example, when the second aggregate particle reaches the target particle diameter in the second aggregate particle forming step, a third resin particle dispersion liquid is added to the second aggregate particle dispersion liquid, and the resulting dispersion liquid is heated at a temperature not higher than the glass transition temperature of the third resin particle.

Then, the pH of the dispersion liquid is adjusted, for example, to the range of approximately from 6.5 to 8.5, whereby the progress of aggregation is stopped.

### —Fusion/Coalescence Step—

Next, the third aggregate particle dispersion liquid having dispersed therein a third aggregate particle is heated, for example, at a temperature not lower than the glass transition temperatures of the first, second and third resin particles (for example, not lower than a temperature higher by 10° C. to 30° C. than the glass transition temperatures of the first, second and third resin particles) to fuse/coalesce the third aggregate particles and form a toner particle.

The toner particle is obtained through these steps.

In the toner particle (toner) obtained through these steps, the distribution characteristics of the eccentricity degree B of the release agent domain fall in the above-described ranges.

After the completion of fusion/coalescence step, the toner particle formed in a solution is subjected to known washing step, solid-liquid separation step and drying step to obtain a dry toner particle.

In the washing step, full displacement washing with ion-exchanged water is preferably applied in view of chargeability. The solid-liquid separation step is not particularly limited, but in view of productivity, suction filtration, pressure filtration, etc. is preferably applied. The drying step is also not particularly limited in its method, but in view of productivity, freeze drying, flash jet drying, fluidized drying, vibration-type fluidized drying, etc. is preferably applied.

The toner according to the first exemplary embodiment of the present invention is produced, for example, by adding an external additive to the obtained dry toner particle and mixing them. The mixing is preferably performed, for example, by a V-blender, a Henschel mixer, or a Lodige mixer. Furthermore, if desired, coarse toner particles may be removed using a vibration sieving machine, a wind power sieving machine, etc.

### (Electrostatic Image-Developing Toner According to a Second Exemplary Embodiment)

The electrostatic image-developing toner (hereinafter referred to as “toner”) according to the second exemplary embodiment of the present invention includes a toner particle containing a binder resin and a release agent, and an external additive containing a silica particle surface-treated with an oil (hereinafter, sometimes referred to as “oil-treated silica particle”).

The toner particle has a sea-island structure involving a sea part containing the binder resin and an island part containing the release agent.

In the sea-island structure, the mode value of the distribution of the eccentricity degree B represented by formula (1) of the release agent-containing island part is from 0.75 to 0.98 and the skewness of the distribution of the eccentricity degree B is from −1.10 to −0.50:

Eccentricity degree B=2d/D Formula (1):

in formula (1), D represents the equivalent-circle diameter (μm) of the toner particle in the cross-sectional observation of the toner particle, and d represents the distance (μm) from the gravity center of the toner particle to the gravity center of the release agent-containing island part in the cross-sectional observation of the toner particle.

Thanks to the configuration above, the toner according to an exemplary embodiment of the present invention suppresses both occurrence of fogging (a phenomenon of attachment of a toner to a non-image area) and reduction in the image density when continuously outputting an image in a low-temperature low-humidity environment (for example, when an image is continuously output on 100,000 sheets of A4 paper in an environment of a temperature of 10° C. and a humidity of 15% RH). The reason therefor is not clearly know but is presumed as follows.

When an oil-treated silica particle is externally added to a toner particle, oil attaches to the surface of the toner particle. The oil attached to the toner particle adsorbs water. This water-adsorbed oil serves as a charge conduction path, and the charge exchangeability of the toner particle is improved. As a result, occurrence of fogging due to poor charge exchangeability (charging failure) of the toner is likely to be suppressed.

However, when an image is continuously output in a low-temperature low-humidity environment, humidity in the image forming apparatus is reduced and in turn, the amount of water adsorbed (or amount of water to be adsorbed) on the oil is reduced. Therefore, even when an oil-treated silica particle is externally added to a toner particle, in the case of continuously outputting an image in a low-temperature low-humidity environment, occurrence of fogging due to poor charge exchangeability (charging failure) of the toner can be hardly suppressed.

On the other hand, it is known to unevenly distribute a release agent to the surface layer part of a toner particle. A toner particle in which a release agent is unevenly distributed to the surface layer is also improved in the charge exchangeability, because the resistance of the surface layer part is lowered. As a result, occurrence of fogging due to poor charge exchangeability (charging failure) of the toner is likely to be suppressed.

However, a toner particle where a release agent is unevenly distributed to the surface layer has high resistance in the inner part and when continuously outputting an image in a low-temperature low-humidity environment, an electric charge tends to excessively accumulate in the toner particle, leading to excessive charging (charge-up) and easy occurrence of a decrease in the image density.

Here, the eccentricity degree B of the release agent-containing island part (hereinafter, sometimes referred to as “release agent domain”) is an indicator indicating how much distant is the gravity center of the release agent domain from the gravity center of the toner particle. A larger value of the eccentricity degree B indicates that the release agent domain is present near the toner surface, and a smaller value indicates that the release agent domain is present near the center of the toner particle. The mode value of the distribution of the eccentricity degree B indicates a region where a largest number of release agent domains are present in the diameter direction of the toner particle. On the other hand, the skewness of the distribution of the eccentricity degree B indicates a bilateral symmetry of the distribution. Specifically, the skewness of the distribution of the eccentricity degree B indicates the degree of tailing of the distribution from the mode value. That is, the skewness of the distribution of the eccentricity degree B indicates to what extent the release agent domain is distributed in the diameter direction of the toner particle from the region where a largest number of domains are present.

More specifically, when the mode value of the distribution of the eccentricity degree B of the release agent domain is from 0.75 to 0.98, this indicates that a largest number of release agent domains are present in the surface layer part of the toner particle. In addition, when the skewness of the distribution of the eccentricity degree B of the release agent domain is from −1.10 to −0.50, this indicates that the release agent domain is distributed with a gradient from the surface layer part toward the inner part of the toner particle (see, FIG. 4).

In this way, the toner particle in which the mode value and skewness of the distribution of the eccentricity degree B of the release agent domain satisfy the above-described ranges is a toner particle where a largest number of release agent domains are present in the surface layer part and at the same time, the domains are distributed with a gradient from the inner part toward the surface layer part of the toner particle. That is, in the toner particle having a gradient in the distribution of the release agent domain, the resistance in the inner part as well as the resistance in the surface layer part are lowered by the release agent.

In addition, when an oil-treated silica particle is externally added to a toner particle having a gradient in the distribution of the release agent domain, the oil attaches to the toner particle surface, and the water adsorbed on the oil is selectively supplied to the release agent domain in the surface layer part of the toner particle. Thereafter, the water is supplied from the release agent domain in the surface layer part of the toner particle to the inner part of the toner particle through release agent domains distributed toward the inner part of the toner particle. Therefore, it is considered that in the toner particle, both the resistance in the surface layer part and the resistance in the inner part are further lowered by water. In addition, since oil is attached to the toner particle surface, the amount of water in the surface layer part as well as in the inner part is less likely to decrease even under low-temperature low-humidity conditions.

In turn, even when an image is continuously output in a low-temperature low-humidity environment, it is easy for the toner particle to maintain the low resistance condition in the surface layer part as well as in the inner part and execute charge exchange to suppress excessive charging (charge-up).

For these reasons, the toner according to the second exemplary embodiment of the present invention is presumed to suppress both occurrence of fogging and reduction in the image density when continuously outputting an image in a low-temperature low-humidity environment.

In this connection, there are conventionally known, for example, a toner in which the position of a release agent is located near the surface by utilizing the difference in the hydrophilicity/hydrophobicity between a binder resin and a release agent which are dissolved in a solvent (JP-A-2004-145243, etc.), and a toner in which the position of a release agent is located near the surface by a kneading pulverization production method using an eccentricity control resin having both a moiety close in porality to a binder resin and a moiety close in polarity to a release agent (JP-A-2011-158758, etc.). However, in all of these toners, the release agent position within a toner is controlled by physical properties of the material and a gradient cannot be imparted to the distribution of the release agent domain of the toner.

Details of the toner according to the second exemplary embodiment of the present invention are described below.

### (Toner Particle)

The toner particle has a sea-island structure involving a binder resin-containing sea part and a release agent-containing island part. That is, the toner particle has a sea-island structure where a release agent is present like islands in a continuous phase of a binder resin. Incidentally, from the standpoint of reducing the release failure, the release agent domain is preferably not present in the central part (gravity center part) of the toner in the cross-sectional observation of the toner.

In the toner particle having a sea-island structure, the mode value of the distribution of the eccentricity degree B of the release agent domain (release agent-containing island part) is from 0.75 to 0.98 and from the standpoint of suppressing occurrence of fogging and suppressing reduction in the image density, preferably from 0.80 to 0.95, more preferably from 0.85 to 0.90. Among others, in view of thermal storability of the toner, the mode value of the distribution of the eccentricity degree B of the release agent domain is preferably 0.98 or less.

The skewness of the distribution of the eccentricity degree B of the release agent domain (release agent-containing island part) is from −1.10 to −0.50 and from the standpoint of suppressing occurrence of fogging and suppressing reduction in the image density, preferably from −1.00 to −0.60, more preferably from −0.95 to −0.65.

In addition, the method for confirming the sea-island structure of the toner particle, the method for measuring the eccentricity degree B of the release agent domain, and the method for calculating the mode value of the distribution of the eccentricity degree B of the release agent domain, and the method for calculating the skewness of the distribution of the eccentricity degree B of the release agent domain are same as the contents explained in the electrostatic image-developing toner according to the first exemplary embodiment.

Moreover, in the electrostatic image-developing toner according to the second exemplary embodiment, it is not necessary to limit a bulk density of the toner. A toner having the bulk density described in the electrostatic image-developing toner according to the first exemplary embodiment may be used.

The constituent components of the toner particle are described below.

The toner particle contains a binder resin and a release agent. Specifically, the toner particle has a toner particle containing a binder resin and a release agent. The toner particle may contain other additives such as coloring agent.

In addition, the binder resin, the release agent, the coloring agent and other additives are same as the binder resin, the release agent, the coloring agent and other additives, described in the electrostatic image-developing toner according to the first exemplary embodiment, and the preferable ranges thereof are also same as those described in the electrostatic image-developing toner according to the first exemplary embodiment.

Moreover, properties, etc. of toner particle is also same as properties, etc. of toner particle described in the electrostatic image-developing toner according to the first exemplary embodiment.

### (External Additive)

The external additive contains an oil-treated silica particle. The oil-treated silica particle is a silica particle surface-treated with an oil.

The silica particle as the target of oil treatment may be sufficient if it is a particle using silica, i.e., SiO₂, as the main component, and may be crystalline or amorphous. Also, the silica particle may be a particle produced using, as a raw material, a silicon compound such as water glass and alkoxysilane or may be a particle obtained by pulverizing quartz.

Specifically, the silica particle includes, for example, a sol-gel silica particle, an aqueous colloidal silica particle, an alcoholic silica particle, a fumed silica particle obtained by a gas phase process, and a fused silica particle.

The oil for treating the surface of the silica particle includes one or more compounds selected from the group consisting of lubricating oils and fats/oils. The oil specifically includes, for example, a silicone oil, a paraffin oil, a fluorine oil, and a vegetable oil. One kind of an oil may be used, or a plurality of kinds of oils may be used.

The silicone oil includes, for example, dimethylsilicone oil, methylphenylsilicone oil, chlorophenylsilicone oil, methylhydrogensilicone oil, alkyl-modified silicone oil, fluorine-modified silicone oil, polyether-modified silicone oil, alcohol-modified silicone oil, amino-modified silicone oil, epoxy-modified silicone oil, epoxy/polyether-modified silicone oil, phenol-modified silicone oil, carboxyl-modified silicone oil, mercapto-modified silicone oil, acryl or methacryl-modified silicone oil, and α-methylstyrene-modified silicone oil.

The paraffin oil includes, for example, liquid paraffin.

The fluorine oil includes, for example, fluorine oil and fluorine chloride oil.

The mineral oil includes, for example, machine oil.

The vegetable oil includes, for example, rapeseed oil and palm oil.

Among these oils, from the standpoint of suppressing occurrence of fogging and suppressing reduction in the image density, a silicone oil is preferred. When a silicone oil is applied, the oil spreads in a thin-film and nearly uniform state on the silica particle to facilitate the surface treatment.

From the standpoint of suppressing occurrence of fogging and suppressing reduction in the image density, the volume average particle diameter of the oil-treated silica particle is preferably from 30 μm to 200 nm, more preferably from 30 nm to 180 nm, still more preferably from 30 μm to 150 μm.

The volume average particle diameter of the oil-treated silica particle is a value measured by the following method.

First, 100 primary particles of the oil-treated silica particle are observed by SEM (Scanning Electron Microscope). Then, the longest diameter and the shortest diameter of each particle are measured by image analysis of the primary particle, and the equivalent-sphere diameter is measured from the median value therebetween. The 50% diameter (D50v) in a cumulative frequency on the volume basis of the obtained equivalent-sphere diameter is defined as the volume average particle diameter of the oil-treated silica particle.

From the standpoint of suppressing occurrence of fogging and suppressing reduction in the image density, the free oil amount of the oil-treated silica particle is preferably from 1 mass % to 10 mass %, more preferably from 3 mass % to 10 mass %, still more preferably from 5 mass % to 10 mass %.

The free oil amount of the oil-treated silica particle is a value measured by the following method.

The oil-treated silica particle is measured by proton NMR by using AL-400 (magnetic field: 9.4 T (H nucleus: 400 MHz) manufactured by JEOL Ltd. The zirconia-made sample tube (diameter: 5 mm) is filled with a sample, a deuterochloroform solvent, and TMS as a reference material. The sample tube is set, and measurement is performed, for example, at a frequency of Δ87 kHz/400 MHz (=Δ20 ppm), a measurement temperature of 25° C., a cumulative number of 16, and a resolution of 0.24 Hz (32,000 point). The peak intensity derived from the free oil is converted into a free oil amount by using a calibration curve.

For example, when dimethylsilicone oil is used as the oil, NMR measurement of an untreated silica particle and the dimethylsilicone oil (an amount of about level 5 is shaken) is performed to create a calibration curve of a free oil amount and an NMR peak intensity, and the free oil amount is calculated using the calibration curve.

In the case of increasing the free oil amount of the oil-treated silica particle, for example, the oil treatment is performed a plurality of times. In the case of decreasing the free oil amount of the oil-treated silica particle, for example, a process involving drying after dipping in a solvent is repeatedly carried out.

From the standpoint of suppressing occurrence of fogging and suppressing reduction in the image density, the oil treating amount of the oil-treated silica particle is preferably from 2 mass % to 30 mass %, more preferably from 5 mass % to 20 mass %, still more preferably from 8 mass % to 15 mass %, based on the total mass of the silica particle (oil-untreated silica particle).

The externally added amount (amount added) of the oil-treated silica particle is, for example, preferably from 0.5 mass % to 5.0 mass %, more preferably from 0.8 mass % to 3.0 mass %, based on the total mass of the toner particle.

In addition, the external additive may be used as the external additive in the electrostatic image-developing toner according to the first exemplary embodiment. The content thereof is same as the content above.

As the external additive, external additives other than the oil-treated silica particle may also be applied.

The other external additives and the preferable ranges thereof are same as those described in the other external additives in the electrostatic image-developing toner according to the first exemplary embodiment.

The method for producing the toner according to the second exemplary embodiment is same as the method for producing the toner according to the first exemplary embodiment. In addition, the external additive in the toner according to the second exemplary embodiment is used as the external additive.

### (Electrostatic Image-Developing Toner According to a Third Exemplary Embodiment)

The electrostatic image-developing toner (hereinafter referred to as “toner”) according to the third exemplary embodiment of the present invention includes a toner particle containing a binder resin and a release agent, and an external additive. The toner particle in the toner according to the third exemplary embodiment of the present invention has a sea-island structure involving a sea part containing the binder resin and an island part containing the release agent.

In the sea-island structure, the mode value of the distribution of the eccentricity degree B represented by formula (1) of the release agent-containing island part is from 0.75 to 0.98 and the skewness of the distribution of the eccentricity degree B is from −1.10 to −0.50:

Eccentricity degree B=2d/D Formula (1):

in formula (1), D represents the equivalent-circle diameter (μm) of the toner particle in the cross-sectional observation of the toner particle, and d represents the distance (μm) from the gravity center of the toner particle to the gravity center of the release agent-containing island part in the cross-sectional observation of the toner particle.

In addition, the external additive contains at least one external additive particle selected from the group consisting of strontium titanate, cerium oxide, barium titanate, calcium carbonate and alumina.

Thanks to the configuration above, the toner according to the third exemplary embodiment of the present invention suppresses generation of a color streak when continuously forming a solid image in a high-temperature high-humidity environment. The reason therefor is not clearly know but is presumed as follows.

In recent years, requirement for image formation (hereinafter, sometimes referred to as “printing”) by an electrophotographic system is increasing on the light printing market such as on-demand printing (a method of printing an image on demand). In this light printing market, printing as not seen in the market of printing within an office or a company (a so-called office printing market) is required. Specifically, continuous printing of a solid image is required in the image printing such as photograph or the package printing.

In the printing above, when an image is formed by using an image forming apparatus equipped with a cleaning unit having a cleaning blade, the residual toner remaining on the image holding member after transfer of the toner image on the image holding member is scraped off by a cleaning blade, and the surface of the image holding member is cleaned. In the case of using a toner containing a toner particle and an external additive, when the residual toner reaches the cleaning blade, the residual toner accumulates on the cleaning blade, and a holdup (toner dam) containing a toner particle and an external additive is created.

In the above-described image forming apparatus, when a solid image is continuously printed, image roughening such as color streak is likely to occur due to a failure in cleaning of the image holding member. In particular, when a solid image is continuously printed in a high-temperature high-humidity environment (for example, 30° C. and 85% RH), a color streak is readily generated. In the case where a solid image is continuously printed, the amount of the residual toner remaining on the image holding member increases and in turn, the amount of the toner accumulates on the cleaning blade increases, leading to the presence of a large amount of residual toner remaining between the image holding member and the cleaning blade. Then, the cleaning blade may be deformed due to frictional resistance of the cleaning blade to the residual toner existing between the image holding member and the cleaning blade. When the cleaning blade is deformed, the residual toner escapes from a part of the cleaning blade, as a result, a cleaning streak is generated.

Conventionally, it is known to unevenly distribute a release agent to the surface layer part of a toner particle. A toner particle containing a release agent unevenly distributed to the surface layer part (hereinafter, sometimes referred to as “release agent-localized toner particle”) has such a property that the release agent is likely to bleed out due to the pressure between the image holding member and the cleaning blade. In the case of forming an image by using a toner containing such a toner particle (hereinafter referred to as “release agent-localized toner particle-containing toner”), bleeding out of the release agent facilitates exertion of a lubricating effect. Therefore, it is considered that the frictional resistance of the cleaning blade to the image holding member and the residual toner is relieved and the cleaning blade is hardly deformed. However, when a solid image is continuously printed in a high-temperature high-humidity environment (for example, 30° C. and 85% RH), a color streak is sometimes generated even with the use of the conventional release agent-localized toner particle-containing toner. This phenomenon is considered to occur because in a high-temperature high-humidity environment, only bleeding out of a release agent from the release agent-localized toner particle-containing toner leaves the lubricating effect low.

Here, the eccentricity degree B of the release agent-containing island part (hereinafter, sometimes referred to as “release agent domain”) is an indicator indicating how much distant is the gravity center of the release agent domain from the gravity center of the toner particle. A larger value of the eccentricity degree B indicates that the release agent domain is present near the toner particle surface, and a smaller value indicates that the release agent domain is present near the center of the toner particle. The mode value of the distribution of the eccentricity degree B indicates a region where a largest number of release agent domains are present in the diameter direction of the toner particle. On the other hand, the skewness of the distribution of the eccentricity degree B indicates a bilateral symmetry of the distribution. Specifically, the skewness of the distribution of the eccentricity degree B indicates the degree of tailing of the distribution from the mode value. That is, the skewness of the distribution of the eccentricity degree B indicates to what extent the release agent domain is distributed in the diameter direction of the toner particle from the region where a largest number of domains are present.

More specifically, when the mode value of the distribution of the eccentricity degree B of the release agent domain is from 0.75 to 0.98, this indicates that a largest number of release agent domains are present in the surface layer part of the toner particle. In addition, when the skewness of the distribution of the eccentricity degree B of the release agent domain is from −1.10 to −0.50, this indicates that the release agent domain is distributed with a gradient from the surface layer part toward the inner part of the toner particle (see, FIG. 4).

In this way, the toner particle in which the mode value and skewness of the distribution of the eccentricity degree B of the release agent domain satisfy the above-described ranges is a toner particle where a largest number of release agent domains are present in the surface layer part and at the same time, the domains are distributed with a gradient from the inner part toward the surface layer part of the toner particle. In other words, this toner particle is a toner particle where the content of the release agent is large in the surface layer part of the toner particle and although the release agent is present in an appropriate amount also in the inner part, the abundance of the release agent is small in the central part.

Also, the toner according to the third exemplary embodiment of the present invention includes an external additive containing at least one external additive particle selected from the group consisting of strontium titanate, cerium oxide, barium titanate, calcium carbonate and alumina. By virtue of containing such an external additive particle, for example, a phenomenon of shaving of the surface layer part of the toner particle or a phenomenon of breaking of the toner particle occurs in the toner dam, and the toner particle is likely to be fractured. In the case of a toner particle where the mode value and skewness of the distribution of the eccentricity degree B of the release agent domain satisfy the above-described ranges, fracture of the toner particle facilitates exposure of the release agent existing in the surface layer part and inner part.

The lubricating effect in the toner particle is increased by these two effects, i.e., bleeding out of the release agent due to pressure between the image holding member and the cleaning blade and exposure of the release agent present in the surface layer part and inner part resulting from fracture. In turn, even when a solid image is continuously printed in a high-temperature high-humidity environment, the frictional resistance of the cleaning blade is readily relieved, and deformation of the cleaning blade is suppressed. As a result, it is considered that generation of a residual toner escaping from the cleaning blade is reduced and occurrence of a color streak when continuously forming a solid image in a high-temperature high-humidity environment is suppressed.

As understood from the foregoing pages, the toner according to the third exemplary embodiment of the present invention has the above-described property and therefore, is presumed to suppress generation of a color streak when continuously forming a solid image in a high-temperature high-humidity environment.

Incidentally, an effect of facilitating recovery of the residual toner is also brought about by fracture of the toner particle accumulated on the cleaning blade.

Details of the toner according to the third exemplary embodiment of the present invention are described below.

### (Toner Particle)

The toner particle in the toner according to the third exemplary embodiment of the present invention has a sea-island structure involving a binder resin-containing sea part and a release agent-containing island part. That is, the toner particle has a sea-island structure where a release agent is present like islands in a continuous phase of a binder resin. In this connection, from the standpoint of reducing the release failure at the time of fixing, the release agent domain is preferably not present in the central part (gravity center part) of the toner particle in the cross-sectional observation of the toner particle.

In the toner particle having a sea-island structure, the mode value of the distribution of the eccentricity degree B of the release agent domain (release agent-containing island part) is from 0.75 to 0.98 and from the standpoint of more suppressing generation of a color streak when continuously forming a solid image in a high-temperature high-humidity environment, preferably from 0.80 to 0.95, more preferably from 0.85 to 0.90. In addition, when the mode value of the distribution of the eccentricity degree B of the release agent domain is in this range, the thermal storability of the toner is excellent.

The skewness of the distribution of the eccentricity degree B of the release agent domain (release agent-containing island part) is from −1.10 to −0.50 and from the standpoint of more suppressing generation of a color streak when continuously forming a solid image in a high-temperature high-humidity environment, preferably from −1.00 to −0.60, more preferably from −0.95 to −0.65.

In addition, the method for confirming the sea-island structure of the toner particle, the method for measuring the eccentricity degree B of the release agent domain, and the method for calculating the mode value of the distribution of the eccentricity degree B of the release agent domain, and the method for calculating the skewness of the distribution of the eccentricity degree B of the release agent domain are same as the contents explained in the electrostatic image-developing toner according to the first exemplary embodiment.

Moreover, in the electrostatic image-developing toner according to the third exemplary embodiment, it is not necessary to limit a bulk density of the toner. A toner having the bulk density described in the electrostatic image-developing toner according to the first exemplary embodiment may be used.

The constituent components of the toner particle are described below.

The toner particle contains a binder resin and a release agent. Specifically, the toner particle has a toner particle containing a binder resin and a release agent. The toner particle may contain other additives such as coloring agent.

In addition, the binder resin, the release agent, the coloring agent and other additives are same as the binder resin, the release agent, the coloring agent and other additives, described in the electrostatic image-developing toner according to the first exemplary embodiment, and the preferable ranges thereof are also same as those described in the electrostatic image-developing toner according to the first exemplary embodiment.

Moreover, properties, etc. of toner particle is also same as properties, etc. of toner particle described in the electrostatic image-developing toner according to the first exemplary embodiment.

### (External Additive)

The toner according to the third exemplary embodiment of the present invention contains the above-described toner particle and an external additive. The external additive contains at least one external additive particle selected from the group consisting of strontium titanate, cerium oxide, barium titanate, calcium carbonate and alumina. One of these external additive particles may be used alone, or two or more thereof may be used.

Among these external additive particles, from the standpoint of controlling the particle diameter and the particle shape and suppressing deformation of the cleaning blade, a cerium oxide particle and a strontium titanate particle are preferred, and a strontium titanate particle is more preferred.

The surface of such an external additive particle may be subjected to a hydrophobizing treatment with a hydrophobizing agent. The hydrophobizing agent includes known surface treating agents and specifically includes, for example, a silane coupling agent and silicone oil.

From the standpoint of suppressing generation of a color streak when continuously forming a solid image in a high-temperature high-humidity environment, the number average diameter of the external additive particle is preferably from 2 μm to 10 μm, more preferably from 3 μm to 7 μm, still more preferably from 4 μm to 6 μm.

When the number average particle diameter is in the range above, the toner particle is more easily fractured by the external additive particle. This is considered because by having a number average particle diameter in the range above, the external additive particle becomes an external additive particle kept from adhesion or fixing to a toner particle and endowed with a high degree of freedom of movement.

The number average particle diameter of the external additive particle is a value measured by the following method.

First, the toner to be measured is observed by a scanning electron microscope (SEM). Then, the equivalent-circle diameter of each of 100 external additive particles to be measured is determined by image analysis, and the equivalent-circle diameter at a number accumulation of 50% (50th particle) from the small diameter side in the distribution on the number basis is defined as the number average particle diameter.

In the image analysis for determining the equivalent-circle diameter of 100 external additive particles to be measured, a two-dimensional image at a magnification of 10,000 times is photographed using an analyzer (ERA-8900, manufactured by Elionix Inc.), the projected area is determined under the condition of 0.010000 μm/pixel by using an image analysis software WinROOF (produced by Mitani Corp.), and the equivalent-circle diameter is determined according to the formula: equivalent-circle diameter=2√(projected area/π).

From the standpoint of suppressing generation of a color streak when continuously forming a solid image in a high-temperature high-humidity environment, the externally added amount (content) of the external additive particle is preferably from 0.02 mass % to 2 mass %, more preferably from 0.05 mass % to 1.5 mass %, still more preferably from 0.1 mass % to 1 mass %, based on the toner particle.

The externally added amount (content) of the external additive particle is determined by quantitatively analyzing the fluorescent X-ray intensity. For example, when a strontium titanate particle is used as the external additive particle, first, 200 mg of a mixture of a toner particle and a strontium titanate particle at a known concentration is formed into a pellet sample by using a tablet forming machine for IR with a diameter of 13 mm and after precisely weighing the mass, the fluorescent X-ray intensity of the pellet sample is measured to determine the peak intensity. The same measurement is performed also on a sample in which the amount of the strontium particle added is changed. A calibration curve is created from these results, and the content of the constituent element (for example, Sr or Ti) of the strontium titanate particle to be measured in practice is quantitatively analyzed using the calibration curve. Thereafter, the externally added amount (content) of the strontium titanate particle is calculated.

In the measurement of the fluorescent X-ray intensity, for example, a fluorescent X-ray analyzer (XRF 1500, manufactured by Shimadzu Corporation) is used, and the sample is measured under the conditions of an X-ray output of 40 V, 70 mA, a measurement area of 10 mmφ and a measurement time of 15 minutes. In the case where the peak derived from the constituent element of the strontium titanate particle to be measured is overlapped with a peak of another element, after analyzing the peaks by ICP (inductively coupled plasma) emission spectrometry or atomic absorption spectrometry, the intensity of the constituent element of the strontium titanate particle to be measured may be determined.

In addition, the external additive may be used as the external additive in the electrostatic image-developing toner according to the first exemplary embodiment. The content thereof is same as the content above.

In addition to such an external additive particle, the external additive may contain other external additives.

The other external additives and the preferable ranges thereof are same as those described in the other external additives in the electrostatic image-developing toner according to the first exemplary embodiment.

The method for producing the toner according to the third exemplary embodiment is same as the method for producing the toner according to the first exemplary embodiment. In addition, the external additive in the toner according to the third exemplary embodiment is used as the external additive.

### (Electrostatic Image-Developing Toner According to a Fourth Exemplary Embodiment)

The electrostatic image-developing toner (hereinafter referred to as “toner”) according to the fourth exemplary embodiment of the present invention includes a toner particle containing a binder resin and a release agent, and an external additive containing a titania particle.

The toner particle has a sea-island structure involving a sea part containing the binder resin and an island part containing the release agent.

In the sea-island structure, the mode value of the distribution of the eccentricity degree B represented by formula (1) of the release agent-containing island part is from 0.75 to 0.98 and the skewness of the distribution of the eccentricity degree B is from −1.10 to −0.50:

Eccentricity degree B=2d/D Formula (1):

in formula (1), D represents the equivalent-circle diameter (μm) of the toner particle in the cross-sectional observation of the toner particle, and d represents the distance (μm) from the gravity center of the toner particle to the gravity center of the release agent-containing island part in the cross-sectional observation of the toner particle.

Thanks to the configuration above, the toner according to the fourth exemplary embodiment of the present invention suppresses both occurrence of fogging (a phenomenon of attachment of a toner to a non-image area) and generation of a color streak when continuously outputting (for example, when an image is continuously output on 100,000 sheets of A4 paper). The reason therefor is not clearly know but is presumed as follows.

When a low-resistant titania particle is externally added to a toner particle, in the case of replenishing a replenishment toner to the developer in a developing device (one example of the developing unit), the charge exchangeability between the toner in the developer and the replenishment toner is increased, whereby occurrence of fogging due to poor charge exchangeability (charging failure) of the toner is likely to be suppressed.

However, the titania particle has a large specific gravity and exhibits a high affinity for the binder resin of the toner particle and when an image is continuously output, the titania particle is readily buried in the surface of the toner particle. Then, the resistance difference between the toner in the developing device and the replenishment toner is increased to deteriorate the charge exchangeability. As a result, occurrence of fogging due to poor charge exchangeability (charging failure) of the toner can be hardly suppressed.

On the other hand, it is known to unevenly distribute a release agent to the surface layer part of a toner particle. In the toner particle where a release agent is unevenly distributed to the surface layer part, the resistance of the surface layer part is reduced, and the charge exchangeability is improved, whereby occurrence of fogging due to poor charge exchangeability (charging failure) of the toner is likely to be suppressed.

However, when a titania particle is externally added to a toner particle containing a release agent unevenly distributed to the surface layer part, a color stream is sometimes generated.

Although the cause thereof is not clearly known, when an image is continuously output and the titania particle is buried in the surface of the toner particle, the titania particle having crystallinity is considered to readily undergo uneven distribution to the release agent in the surface layer part of the toner particle. When the toner in this state receives pressure in the cleaning part that is a contact part between the image holding member and the cleaning blade, the release agent attached with a titania particle is exposed to the surface of the toner particle. At this time, the titania particle is thought to become a massive material by attaching to a release agent and increase in the apparent particle diameter. Furthermore, attachment of a titania particle is considered to reduce the releasability of the release agent. As a result, it is believed that pressure in the cleaning part causes the massive material of the titania particle to streakily polish the image holding member and the polishing trace emerges as a streaky image defect.

Here, the eccentricity degree B of the release agent-containing island part (hereinafter, sometimes referred to as “release agent domain”) is an indicator indicating how much distant is the gravity center of the release agent domain from the gravity center of the toner particle. A larger value of the eccentricity degree B indicates that the release agent domain is present near the toner surface, and a smaller value indicates that the release agent domain is present near the center of the toner particle. The mode value of the distribution of the eccentricity degree B indicates a region where a largest number of release agent domains are present in the diameter direction of the toner particle. On the other hand, the skewness of the distribution of the eccentricity degree B indicates a bilateral symmetry of the distribution. Specifically, the skewness of the distribution of the eccentricity degree B indicates the degree of tailing of the distribution from the mode value. That is, the skewness of the distribution of the eccentricity degree B indicates to what extent the release agent domain is distributed in the diameter direction of the toner particle from the region where a largest number of domains are present.

More specifically, when the mode value of the distribution of the eccentricity degree B of the release agent domain is from 0.75 to 0.98, this indicates that a largest number of release agent domains are present in the surface layer part of the toner particle. In addition, when the skewness of the distribution of the eccentricity degree B of the release agent domain is from −1.10 to −0.50, this indicates that the release agent domain is distributed with a gradient from the surface layer part toward the inner part of the toner particle (see, FIG. 4).

In this way, the toner particle in which the mode value and skewness of the distribution of the eccentricity degree B of the release agent domain satisfy the above-described ranges is a toner particle where a largest number of release agent domains are present in the surface layer part and at the same time, the domains are distributed with a gradient from the inner part toward the surface layer part of the toner particle. That is, in the toner particle having a gradient in the distribution of the release agent domain, the resistance in the inner part as well as the resistance in the surface layer part are lowered by the release agent.

Furthermore, when a titania particle is externally added to a toner particle having a gradient in the distribution of the release agent domain and the titania particle is buried in the surface of the toner particle, this is considered to create a state where the titania particle is unevenly distributed only to the release agent domain in the surface layer part of the toner particle. When the toner in this state receives pressure in the cleaning part that is a contact part between the image holding member and the cleaning blade, the titania particle-attached release agent in the surface layer part is exposed to the surface of the toner particle, and at the same time, the release agent distributed in the inner part of the toner particle is exposed or bleeds out. The release agent distributed in the inner part of the toner particle is not attached with a titania particle and is not reduced in the releasability. It is considered that the release agent distributed in the inner part of the toner particle exerts the releasability and even when a massive material of a titania particle increased in the apparent particle diameter is produced resulting from attachment of a titania particle to a release agent in the surface layer part of the toner particle, streaky polishing of the image holding member by the massive material of a titania particle is suppressed.

For these reasons, the toner according to the fourth exemplary embodiment of the present invention is presumed to suppress both occurrence of fogging and generation of a color streak when continuously outputting an image.

In this connection, there are conventionally known, for example, a toner in which the position of a release agent is located near the surface by utilizing the difference in the hydrophilicity/hydrophobicity between a binder resin and a release agent which are dissolved in a solvent (JP-A-2004-145243, etc.), and a toner in which the position of a release agent is located near the surface by a kneading pulverization production method using an eccentricity control resin having both a moiety close in porality to a binder resin and a moiety close in polarity to a release agent (JP-A-2011-158758, etc.). However, in all of these toners, the release agent position within a toner is controlled by physical properties of the material and a gradient cannot be imparted to the distribution of the release agent domain of the toner.

Details of the toner according to the fourth exemplary embodiment of the present invention are described below.

### (Toner Particle)

The toner particle has a sea-island structure involving a binder resin-containing sea part and a release agent-containing island part. That is, the toner particle has a sea-island structure where a release agent is present like islands in a continuous phase of a binder resin. Incidentally, from the standpoint of reducing the release failure, the release agent domain is preferably not present in the central part (gravity center part) of the toner in the cross-sectional observation of the toner.

In the toner particle having a sea-island structure, the mode value of the distribution of the eccentricity degree B of the release agent domain (release agent-containing island part) is from 0.75 to 0.98 and from the standpoint of suppressing occurrence of fogging and suppressing generation of a color streak, preferably from 0.80 to 0.95, more preferably from 0.85 to 0.90. Among others, in view of thermal storability of the toner, the mode value of the distribution of the eccentricity degree B of the release agent domain is preferably 0.98 or less.

The skewness of the distribution of the eccentricity degree B of the release agent domain (release agent-containing island part) is from −1.10 to −0.50 and from the standpoint of suppressing occurrence of fogging and suppressing generation of a color streak, preferably from −1.00 to −0.60, more preferably from −0.95 to −0.65.

In addition, the method for confirming the sea-island structure of the toner particle, the method for measuring the eccentricity degree B of the release agent domain, and the method for calculating the mode value of the distribution of the eccentricity degree B of the release agent domain, and the method for calculating the skewness of the distribution of the eccentricity degree B of the release agent domain are same as the contents explained in the electrostatic image-developing toner according to the first exemplary embodiment.

Moreover, in the electrostatic image-developing toner according to the third exemplary embodiment, it is not necessary to limit a bulk density of the toner. A toner having the bulk density described in the electrostatic image-developing toner according to the first exemplary embodiment may be used.

The constituent components of the toner particle are described below.

The toner particle contains a binder resin and a release agent. Specifically, the toner particle has a toner particle containing a binder resin and a release agent. The toner particle may contain other additives such as coloring agent.

In addition, the binder resin, the release agent, the coloring agent and other additives are same as the binder resin, the release agent, the coloring agent and other additives, described in the electrostatic image-developing toner according to the first exemplary embodiment, and the preferable ranges thereof are also same as those described in the electrostatic image-developing toner according to the first exemplary embodiment.

Moreover, properties, etc. of toner particle is also same as properties, etc. of toner particle described in the electrostatic image-developing toner according to the first exemplary embodiment.

### (External Additive)

The external additive contains a titania particle. The titania particle includes, for example, an anatase titania particle, a rutile titania particle, and a metatitanic acid particle. Among these, from the standpoint of suppressing occurrence of fogging and suppressing generation of a color streak, a metatitanic acid particle is preferred.

From the standpoint of suppressing occurrence of fogging and suppressing generation of a color streak, the volume average particle diameter of the titania particle is preferably from 20 nm to 50 nm, more preferably from 25 nm to 50 nm, still more preferably from 30 nm to 50 nm.

The volume average particle diameter of the titania particle is a value measured by the following method.

First, 100 primary particles of the titania particle are observed by SEM (Scanning Electron Microscope). Then, the longest diameter and the shortest diameter of each particle are measured by image analysis of the primary particle, and the equivalent-sphere diameter is measured from the median value therebetween. The 50% diameter (D50v) in a cumulative frequency on the volume basis of the obtained equivalent-sphere diameter is defined as the volume average particle diameter of the titania particle.

The titania particle may be subjected to a hydrophobizing treatment. The hydrophobizing treatment is performed, for example, by immersing the titania particle in a hydrophobizing agent. The hydrophobizing agent used for the hydrophobizing treatment includes, for example, a silane coupling agent and silicone oil.

The silane coupling agent includes, for example, hexamethyldisilazane, trimethylsilane, trimethylchlorosilane, dimethyldichlorosilane, methyltrichlorosilane, allyldimethylchlorosilane, benzyldimethylchlorosilane, methyltrimethoxysilane, methyltriethoxysilane, isobutyltrimethoxysilane, dimethyldimethoxysilane, dimethyldiethoxysilane, trimethylmethoxysilane, hydroxypropyltrimethoxysilane, phenyltrimethoxysilane, n-butyltrimethoxysilane, n-hex adecyltrimethoxysilane, n-octadecyltrimethoxysilane, vinyltrimethoxysilane, vinyltriethoxysilane, γ-methacryloxypropyltrimethoxysilane, and vinyltriacetoxysilane.

The silicone oil includes, for example, dimethylpolysiloxane, methylhydrozinepolysiloxane, and methylphenylpolysiloxane.

In addition, the hydrophobizing agent also includes known hydrophobizing agents such as titanate coupling agent and aluminum coupling agent.

One hydrophobizing agent may be used alone, or two or more hydrophobizing agents may be used in combination.

The externally added amount (amount added) of the titania particle is, for example, preferably from 0.3 mass % to 5.0 mass %, more preferably from 0.7 mass % to 3.0 mass %, based on the total mass of the toner particle.

In addition, the external additive may be used as the external additive in the electrostatic image-developing toner according to the first exemplary embodiment. The content thereof is same as the content above.

As the external additive, external additives other than the titania particle may also be applied.

The other external additives and the preferable ranges thereof are same as those described in the other external additives in the electrostatic image-developing toner according to the first exemplary embodiment.

The method for producing the toner according to the fourth exemplary embodiment is same as the method for producing the toner according to the first exemplary embodiment. In addition, the external additive in the toner according to the fourth exemplary embodiment is used as the external additive.

### <Electrostatic Image Developer>

The electrostatic image developer according to an exemplary embodiment of the present invention contains at least the toner according to any of the first to fourth exemplary embodiments of the present invention.

The electrostatic image developer according to an exemplary embodiment of the present invention may be a single-component developer containing only the toner according to any of the first to fourth exemplary embodiments of the present invention or may be a two-component developer wherein the toner and a carrier are mixed.

The carrier is not particularly limited and examples thereof include known carriers. The carrier includes, for example, a coated carrier obtained by applying a coating resin onto the surface of a core material composed of a magnetic material; a magnetic powder dispersion-type carrier obtained by dispersing/blending a magnetic powder in a matrix resin; and a resin-impregnated carrier obtained by impregnating a porous magnetic powder with a resin.

Incidentally, the magnetic powder dispersion-type carrier and the resin-impregnated carrier may be a carrier where a constituent particle of the carrier is used as a core material and coated with a coating resin.

The magnetic powder includes, for example, a magnetic metal such as iron, nickel and cobalt, and a magnetic oxide such as ferrite and magnetite.

The coating resin and matrix resin include, for example, polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylic acid copolymer, an organosiloxane bond-containing straight silicone resin or a modified product thereof, fluororesin, polyester, polycarbonate, phenolic resin, and epoxy resin.

Incidentally, in the coating resin and matrix resin, other additives such as electrically conductive particle may be incorporated.

The electrically conductive particle includes particles of a metal such as gold, silver and copper, carbon black, titanium oxide, zinc oxide, tin oxide, barium sulfate, aluminum borate, potassium titanate, etc.

The method for applying a coating resin onto the surface of a core material includes, for example, a method of applying a coating layer-forming solution obtained by dissolving the coating resin and, if desired, various additives in an appropriate solvent. The solvent is not particularly limited and may be selected taking into account the coating resin used, suitability for coating, and the like.

Specific examples of the resin coating method include a dipping method of dipping the core material in the coating layer-forming solution, a spray method of spraying the coating layer-forming solution onto the core material surface, a fluidized bed method of spraying the coating layer-forming solution in the state of the core material being floated by fluidizing air, and a kneader-coater method of mixing the core material of the carrier with the coating layer-forming solution in a kneader-coater and removing the solvent.

The mixing ratio (mass ratio) between the toner and the carrier in the two-component developer is preferably toner:carrier=from 1:100 to 30:100, more preferably from 3:100 to 20:100.

### <Image Forming Apparatus/Image Forming Method>

The image forming apparatus/image forming method according to an exemplary embodiment of the present invention are described.

The image forming apparatus according to an exemplary embodiment of the present invention is equipped with an image holding member, a charging unit for charging the surface of the image holding member, an electrostatic image forming unit for forming an electrostatic image on the charged surface of the image holding member, a developing unit for storing an electrostatic image developer and developing the electrostatic image formed on the surface of the image holding member with the electrostatic image developer to form a toner image, a transfer unit for transferring the toner image formed on the surface of the image holding member onto the surface of a recording medium, a cleaning unit having a cleaning blade for cleaning the surface of the image holding member, and a fixing unit for fixing the toner image transferred onto the surface of the recording medium. As the electrostatic image developer, the electrostatic image developer according to an exemplary embodiment of the present invention is applied.

In the image forming apparatus according to an exemplary embodiment of the present invention, an image forming method including a charging step of charging the surface of an image holding member, an electrostatic image forming step of forming an electrostatic image on the charged surface of the image holding member, a developing step of developing the electrostatic image formed on the surface of the image holding member with the electrostatic image developer according to an exemplary embodiment of the present invention to form a toner image, a transfer step of transferring the toner image formed on the surface of the image holding member onto the surface of a recording medium, a cleaning step of cleaning the surface of the image holding member with a cleaning blade, and a fixing step of fixing the toner image transferred onto the surface of the recording medium (the image forming method according to an exemplary embodiment of the present invention) is performed.

As for the image forming apparatus according to an exemplary embodiment of the present invention, there is applied a known image forming apparatus, e.g., a direct transfer-type apparatus where a toner image formed on the surface of an image holding member is transferred directly onto a recording medium; an intermediate transfer-type apparatus where a toner image formed on the surface of an image holding member is primarily transferred onto the surface of an intermediate transfer material and the toner image transferred onto the surface of the intermediate transfer material is secondarily transferred onto the surface of a recording medium; or an apparatus equipped with a destaticizing unit for irradiating the surface of an image holding member after transfer of a toner image but before charging, with destaticizing light to remove electrostatic charge.

In the case of an intermediate transfer-type apparatus, a configuration having, for example, an intermediate transfer material onto the surface of which a toner image is transferred, a primary transfer unit for primarily transferring a toner image formed on the surface of an image holding member onto the surface of the intermediate transfer material, and a secondary transfer unit for secondarily transferring the toner image transferred onto the surface of the intermediate transfer material, onto the surface of a recording medium, is applied to the transfer unit.

Incidentally, in the image forming apparatus according to an exemplary embodiment of the present invention, for example, the portion containing the developing unit may be a cartridge structure (process cartridge) that is attached to and detached from the image forming apparatus. As the process cartridge, for example, a process cartridge storing the electrostatic image developer according to an exemplary embodiment of the present invention and having a developing unit is suitably used.

One example of the image forming apparatus according to an exemplary embodiment of the present invention is described below, but the present invention is not limited thereto. Incidentally, main parts depicted in the figure are described, and description of others is omitted.

FIG. 1 is a schematic configuration diagram depicting an image forming apparatus according to an exemplary embodiment of the present invention.

The image forming apparatus depicted in FIG. 1 is equipped with first to fourth electrophotographic image forming units 10Y, 10M, 10C and 10K (image forming unit) for outputting an image of each color of yellow (Y), magenta (M), cyan (C) and black (K) based on the color-separated image data. These image forming units (hereinafter, sometimes simply referred to as “unit”) 10Y, 10M, 10C and 10K are arranged in parallel with a predetermined spacing from each other in the horizontal direction. Incidentally, these units 10Y, 10M, 10C and 10K may be a process cartridge that is attached to and detached from the image forming apparatus.

Above respective units 10Y, 10M, 10C and 10K in the figure, an intermediate transfer belt 20 is disposed extending as an intermediate transfer material over respective units. The intermediate transfer belt 20 is provided by winding it around a drive roller 22 and a support roller 24 put into contact with the inner surface of the intermediate transfer belt 20, these rollers being arranged to be apart from each other in the left-to-right direction in the figure, and is configured to run in the direction toward fourth unit 10K from first unit 10Y. Incidentally, the support roller 24 is biased in the direction away from the drive roller 22 by a spring, etc. (not shown), and a tension is applied to the intermediate transfer belt 20 wound around those two rollers. An intermediate transfer material cleaning device 30 is provided on the image holding member-side surface of the intermediate transfer belt 20 to face the drive roller 22.

Toners including toners of four colors of yellow, magenta, cyan and black, which are stored in toner cartridges 8Y, 8M, 8C and 8K, are supplied respectively to developing devices (developing units) 4Y, 4M, 4C and 4K of respective units 10Y, 10M, 10C and 10K.

First to fourth units 10Y, 10M, 10C and 10K have the same configuration and therefore, first unit 10Y for forming a yellow image, which is arranged on the upstream side in the running direction of the intermediate transfer belt, is described here as a representative of those units. Incidentally, description of second to fourth units 10M, 10C and 10K is omitted by assigning a reference numeral of magenta (M), cyan (C) or black (K) in place of yellow (Y) to the part equivalent to that in first unit 10Y.

First unit 10Y has a photoreceptor 1Y acting as an image holding member. A charging roller (one example of the charging unit) 2Y for charging the surface of the photoreceptor 1Y to a predetermined potential, an exposure device (one example of the electrostatic image forming unit) 3 for exposing the charged surface to a laser beam 3Y based on color-separated image signals to form an electrostatic image, a developing device (one example of the developing unit) 4Y for developing the electrostatic image by supplying a charged toner to the electrostatic image, a primary transfer roller (one example of the primary transfer unit) 5Y for transferring the developed toner image onto the intermediate transfer belt 20, and a photoreceptor cleaning device (one example of the cleaning unit) 6Y having a cleaning blade 6Y-1 for removing the toner remaining on the surface of the photoreceptor 1Y after the primary transfer are sequentially disposed on the periphery of the photoreceptor 1Y.

Incidentally, the primary transfer roller 5Y is arranged inside of the intermediate transfer belt 20 and is provided at a position facing the photoreceptor 1Y. Furthermore, a bias power source (not shown) for applying a primary transfer bias is connected to each of the primary transfer rollers 5Y, 5M, 5C and 5K. Each bias power source can change the transfer bias applied to each primary transfer roller, by control of a controller (not shown).

The operation of forming a yellow image in first unit 10Y is described below. First, the surface of the photoreceptor 1Y is charged to a potential of −600 V to −800 V by a charging roller 2Y in advance of operation.

The photoreceptor 1Y is formed by stacking a photosensitive layer on an electrically conductive (for example, volume resistivity at 20° C.: 1×10⁻⁶ Ωcm or less) substrate. This photosensitive layer has a property such that the resistance is usually high (resistance of a general resin) but upon irradiation with a laser beam 3Y, the specific resistance of the portion irradiated with the laser beam varies. Therefore, a laser beam 3Y is output through the exposure device 3 onto the charged surface of the photoreceptor 1Y according to yellow image data transmitted from a controller (not shown). The photosensitive layer on the surface of the photoreceptor 1Y is irradiated with the laser beam 3Y, whereby an electrostatic image of a yellow image pattern is formed on the surface of the photoreceptor 1Y.

The electrostatic image is an image formed on the surface of the photoreceptor 1Y by charging and is a so-called negative latent image formed in such a manner that the specific resistance of the photosensitive layer in the portion irradiated with the laser beam 3Y lowers to allow the electric charge charged on the surface of the photoreceptor 1Y to flow and on the other hand, the electric charge in the portion not irradiated with the laser beam 3Y remain.

The electrostatic image formed on the photoreceptor 1Y is rotated to a predetermined development position along with running of the photoreceptor 1Y. At this development position, the electrostatic image on the photoreceptor 1Y is visualized (developed) as a toner image by the developing device 4Y.

In the developing device 4Y, for example, an electrostatic image developer containing at least a yellow toner and a carrier is stored. The yellow toner is frictionally charged by agitation inside the developing device 4Y to have an electric charge with the same polarity (negative polarity) as that of the electric charge charged on the photoreceptor 1Y and is thereby held on a developer roll (one example of the developer holding member). In the course of the photoreceptor 1Y surface passing through the developing device 4Y, the yellow toner electrostatically adheres to the destaticized latent image part on the photoreceptor 1Y surface, and the latent image is developed with the yellow toner. The photoreceptor 1Y having formed thereon a yellow toner image is caused to continuously run at a predetermined speed, and the toner image developed on the photoreceptor 1Y is conveyed to a predetermined primary transfer position.

When the yellow toner image on the photoreceptor 1Y is conveyed to the primary transfer position, a primary transfer bias is applied to the primary transfer roller 5Y, and an electrostatic force directed from the photoreceptor 1Y to the primary transfer roller 5Y acts on the toner image, as a result, the toner image on the photoreceptor 1Y is transferred onto the intermediate transfer belt 20. The transfer bias applied here has (+) polarity opposite the polarity (−) of the toner and, for example, in first unit 10Y, the transfer bias is controlled to +10 μA by a controller (not shown).

On the other hand, the toner remaining on the photoreceptor 1Y is removed by the cleaning blade 6Y-1 of the photoreceptor cleaning device 6Y and collected.

The primary transfer biases applied to the primary transfer rollers 5M, 5C and 5K of second unit 10M and subsequent units are also controlled in accordance with the first unit.

In this way, the intermediate transfer belt 20 having the yellow toner image transferred in the first unit 10Y is sequentially conveyed over second to fourth units 10M, 10C and 10K, and toner images of respective colors are superposed and multi-transferred.

The intermediate transfer belt 20, onto which toner images of four colors are multi-transferred through first to fourth units, reaches a secondary transfer part composed of the intermediate transfer belt 20, the support roller 24 in contact with the inner surface of the intermediate transfer belt, and a secondary transfer roller (one example of the secondary transfer unit) 26 disposed on the image holding surface side of the intermediate transfer belt 20. On the other hand, recording paper (one example of the recording medium) P is fed through a feed mechanism at a predetermined timing to a gap where the secondary transfer roller 26 comes into contact with the intermediate transfer belt 20, and a secondary transfer bias is applied to the support roller 24. The transfer bias applied here has (−) polarity that is the same as the polarity (−) of the toner, and an electrostatic force directed from the intermediate transfer belt 20 to the recording paper P acts on the toner image, as a result, the toner images on the intermediate transfer belt 20 are transferred onto the recording paper P. Incidentally, this secondary transfer bias is determined according to the resistance detected by a resistance detecting unit (not shown) for detecting the resistance of the secondary transfer part and is voltage-controlled.

Thereafter, the recording paper P is delivered to a pressure-contact part (nip part) of a pair of fixing rollers in the fixing device (one example of the fixing unit) 28, and the toner images are fixed on the recording paper P, whereby a fixed image is formed.

The recording paper P onto which the toner images are transferred includes, for example, plain paper used for an electrophotographic copying machine, a printer, etc. The recording medium also includes OHP sheet, etc., in addition to the recording paper P.

In order to further improve the smoothness of the image surface after fixing, the surface of the recording paper P is also preferably smooth and, for example, coated paper obtained by coating the surface of plain paper with a resin, etc., and art paper for printing are suitably used.

The recording paper P after the completion of fixing of a color image is conveyed toward the ejection part, and a series of color image forming operations are terminated.

### <Process Cartridge/Toner Cartridge>

The process cartridge according to an exemplary embodiment of the present invention is described.

The process cartridge according to an exemplary embodiment of the present invention is a process cartridge that is attached to and detached from the image forming apparatus and equipped with a developing unit for storing the electrostatic image developer according to an exemplary embodiment of the present invention and developing the electrostatic image formed on the surface of the image holding member with the electrostatic image developer to form a toner image.

Incidentally, the process cartridge according to an exemplary embodiment of the present invention is not limited to the above-described configuration and may be configured to have a developing device and, if desired, additionally have, for example, at least one member selected from other units such as image holding member, charging unit, electrostatic image forming unit and transfer unit.

One example of the process cartridge according to an exemplary embodiment of the present invention is described below, but the present invention is not limited thereto. Incidentally, main parts depicted in the figure are described, and description of others is omitted.

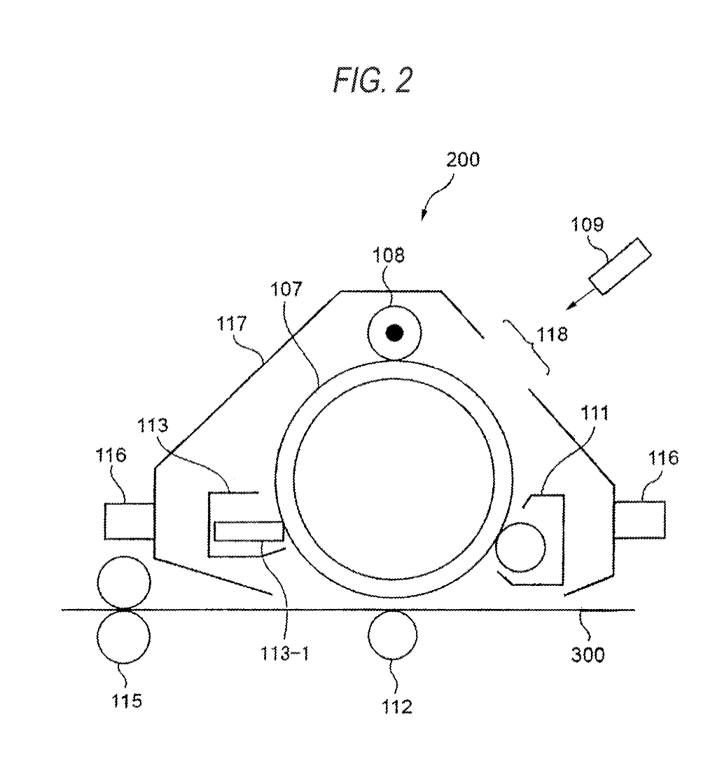

FIG. 2 is a schematic configuration diagram illustrating the process cartridge according to an exemplary embodiment of the present embodiment.

The process cartridge 200 depicted in FIG. 2 has a configuration where, for example, a photoreceptor 107 (one example of the image holding member), a charging roller 108 (one example of the charging unit) disposed on the periphery of the photoreceptor 107, a developing device 111 (one example of the developing unit), and a photoreceptor cleaning device 113 (one example of the cleaning unit) having a cleaning blade 113-1 are held in an integrally combined manner by a mounting rail 116 and a housing 117 with an opening 118 for exposure and formed into a cartridge.

Incidentally, in FIG. 2, 109 indicates an exposure device (one example of the electrostatic image forming unit), 112 indicates a transfer device (one example of the transfer unit), 115 indicates a fixing device (one example of the fixing unit), and 300 indicates recording paper sheet (one example of the recording medium).

The toner cartridge according to an exemplary embodiment of the present invention is described below.

The toner cartridge according to an exemplary embodiment of the present invention is a toner cartridge storing the toner according to an exemplary embodiment of the present invention and being attached to and detached from an image forming apparatus. The toner cartridge is a unit for storing a replenishment toner supplied to the developing unit provided in the image forming apparatus.

The image forming apparatus depicted in FIG. 1 is an image forming apparatus having a configuration where toner cartridges 8Y, 8M, 8C and 8K are attached and detached, and developing devices 4Y, 4M, 4C and 4K are connected to toner cartridges corresponding to respective developing devices (colors) by toner supply pipes (not shown). In the case where the amount of the toner stored in the toner cartridge is reduced, this toner cartridge is replaced.

### EXAMPLES

The exemplary embodiment of the present invention is described in greater detail below by referring to Examples and Comparative Examples, but the exemplary embodiment of the present invention is not limited to these Examples. Incidentally, unless otherwise indicated, the “parts” means “parts by mass”.

### Examples 1 to 9 and Comparative Examples 1 to 7

### Preparation of Resin Particle Dispersion Liquid

### [Preparation of Resin Particle Dispersion Liquid (1)]

Terephthalic acid: 30 molar parts

Fumaric acid: 70 molar parts

Bisphenol A ethylene oxide adduct: 5 molar parts

Bisphenol A propylene oxide adduct: 95 molar parts

These materials are charged into a flask having an internal volume of 5 liter and being equipped with a stirring device, a nitrogen inlet tube, a temperature sensor and a rectifying column. The temperature is raised to 210° C. over 1 hour, and 1 part of titanium tetraethoxide is charged per 100 parts of the materials above. The temperature is raised to 230° C. over 0.5 hours while distilling out water produced and after continuing the dehydration condensation reaction for 1 hour at this temperature, the reaction product is cooled. In this way, Polyester Resin (1) having a weight average molecular weight of 18,500, an acid value of 14 mgKOH/g and a glass transition temperature of 59° C. is synthesized.

40 Parts of ethyl acetate and 25 parts of 2-butanol are charged into a vessel equipped with a temperature adjusting unit and a nitrogen purging unit to prepare a mixed solvent. Thereafter, 100 parts of Polyester Resin (1) is gradually charged and dissolved, and an aqueous 10 mass % ammonia solution (in an amount corresponding to 3 times, in terms of molar ratio, the acid value of the resin) is added thereto, followed by stirring for 30 minutes.

Subsequently, the inside of the vessel is purged with dry nitrogen, and 400 parts of ion-exchanged water is added dropwise at a rate of 2 parts/min by keeping the temperature at 40° C. while stirring the mixed solution, thereby effecting emulsification. After the completion of dropwise addition, the emulsified liquid is returned to room temperature (from 20° C. to 25° C.), and the content of ethyl acetate and 2-butanol is decreased to 1,000 ppm or less by bubbling dry nitrogen through the solution for 48 hours with stirring to obtain a resin particle dispersion liquid in which resin particles having a volume average particle diameter of 200 nm are dispersed. Ion-exchanged water is added to this resin particle dispersion liquid to adjust the solid content to 20 mass %, and the resulting dispersion liquid is designated as Resin Particle Dispersion Liquid (1).

### <Preparation of Coloring Agent Particle Dispersion Liquid>

### [Preparation of Coloring Agent Particle Dispersion Liquid (1)]

Cyan pigment, C.I. Pigment Blue 15:3 (copper 70 parts phthalocyanine, produced by DIC Corp., trade name: FASTOGEN BLUE LA5380):

Anionic surfactant (Neogen RK, produced by Dai-Ichi Kogyo Seiyaku Co., Ltd.): 5 parts

Ion-exchanged water: 200 parts

These materials are mixed and dispersed for 10 minutes by using a homogenizer (ULTRA-TURRAX T50, manufactured by IKA), and ion-exchanged water is added to adjust the solid content in the dispersion liquid to 20 mass %, whereby Coloring Agent Particle Dispersion Liquid (1) wherein coloring agent particles with a volume average particle diameter of 190 nm are dispersed therein is obtained.

### <Preparation of Release Agent Particle Dispersion Liquid>

### [Preparation of Release Agent Particle Dispersion Liquid (1)]

Paraffin wax (HNP-9, produced by Nippon Seiro Co., Ltd.): 100 parts

Anionic surfactant (Neogen RK, produced by Dai-Ichi Kogyo Seiyaku Co., Ltd.): 1 part

Ion-exchanged water: 350 parts

These materials are mixed, heated at 100° C., dispersed using a homogenizer (ULTRA-TURRAX T50, manufactured by IKA), and then subjected to a dispersion treatment by means of a Manton Gaulin high-pressure homogenizer (manufactured by Gaulin Corp.) to obtain Release Agent Particle Dispersion Liquid (1) (solid content: 20 mass %) wherein release agent particles with a volume average particle diameter of 200 nm are dispersed therein.

### <Production of Toner Particle>

### [Production of Toner Particle (1)]

An apparatus where a round stainless steel-made flask and a vessel A are connected by a tube pump A, a solution stored in the vessel A is fed to the flask by the drive of the tube pump A, the vessel A and a vessel B are connected by a tube pump B, and a solution stored in the vessel B is fed to the vessel A by the drive of the tube pump B, is prepared (see, FIG. 3). The following operation is carried out by using this apparatus.

Resin Particle Dispersion Liquid (1): 500 parts

Coloring Agent Particle Dispersion Liquid (1): 40 parts

Anionic surfactant (TaycaPower): 2 parts

These materials are put in the round stainless steel-made flask and after adjusting the pH to 3.5 by adding 0.1 N nitric acid, 30 parts of an aqueous nitric acid solution having a polyaluminum chloride concentration of 10 mass % is added. Subsequently, the mixture is dispersed at 30° C. by using a homogenizer (ULTRA-TURRAX T50, manufactured by IKA), and thereafter, the temperature is raised at a rate of 1° C./30 min in an oil bath for heating to grow the particle diameter of aggregate particles.

On the other hand, 150 parts of Resin Particle Dispersion Liquid (1) is put in the vessel A that is a polyester-made bottle, and 25 parts of Release Agent Particle Dispersion Liquid (1) is put in the vessel B. Then, the liquid feed rate of the tube pump A and the liquid feed rate of the tube pump B are set to 0.70 parts/1 min and 0.14 parts/1 min, respectively, and when the temperature in the round stainless steel-made flask under the formation of aggregate particles reached 37.0° C., the tube pumps A and B are driven to start feed of respective dispersion liquids, whereby a mixed dispersion liquid having dispersed therein a resin particle and a release agent particle is fed from the vessel A to the round stainless steel-made flask under the formation of aggregate particles while gradually increasing the concentration of the release agent particle.

The resulting mixture is held for 30 minutes from the time when feed of respective dispersion liquids to the flask is completed and the temperature in the flask reaches 48° C., and a second aggregate particle is thereby formed.

Thereafter, 50 parts of Resin Particle Dispersion Liquid (1) is slowly added, and the mixture is held for 1 hour. After adjusting the pH to 8.5 by adding an aqueous 0.1 N sodium hydroxide solution, the mixture is heated to 85° C. while continuously stirring, held for 5 hours, then cooled to 20° C. at a rate of 20° C./min, filtered, thoroughly washed with ion-exchanged water, and dried to obtain Toner Particle (1) having a volume average particle diameter of 6.0 μm.

### [Production of Toner Particle (2)]

Toner Particle (2) is obtained in the same manner as Toner Particle (1) except that in the production of Toner Particle (1), the liquid feed rate of the tube pump A and the liquid feed rate of the tube pump B are set to 0.70 parts/1 min and 0.14 parts/1 min, respectively, and the tube pumps A and B are driven when the temperature in the flask reaches 33.0° C.

### [Production of Toner Particle (3)]

Toner Particle (3) is obtained in the same manner as Toner Particle (1) except that in the production of Toner Particle (1), the liquid feed rate of the tube pump A and the liquid feed rate of the tube pump B are set to 0.85 parts/1 min and 0.14 parts/1 min, respectively, and the tube pumps A and B are driven when the temperature in the flask reaches 37.0° C.

### [Production of Toner Particle (4)]

Toner Particle (4) is obtained in the same manner as Toner Particle (1) except that in the production of Toner Particle (1), the liquid feed rate of the tube pump A and the liquid feed rate of the tube pump B are set to 0.70 parts/1 min and 0.14 parts/1 min, respectively, and the tube pumps A and B are driven when the temperature in the flask reached 40.0° C.

### [Production of Toner Particle (5)]

Toner Particle (5) is obtained in the same manner as Toner Particle (1) except that in the production of Toner Particle (1), the liquid feed rate of the tube pump A and the liquid feed rate of the tube pump B are set to 0.55 parts/1 min and 0.14 parts/1 min, respectively, and the tube pumps A and B are driven when the temperature in the flask reaches 35.0° C.

### [Production of Comparative Toner Particle (C1)]

Comparative Toner Particle (C1) is obtained in the same manner as Toner Particle (1) except that in the production of Toner Particle (1), the liquid feed rate of the tube pump A and the liquid feed rate of the tube pump B are set to 0.90 parts/1 min and 0.14 parts/1 min, respectively, and the tube pumps A and B are driven when the temperature in the flask reached 32.0° C.

### [Production of Comparative Toner Particle (C2)]

Comparative Toner Particle (C2) is obtained in the same manner as Toner Particle (1) except that in the production of Toner Particle (1), the liquid feed rate of the tube pump A and the liquid feed rate of the tube pump B are set to 0.70 parts/1 min and 0.14 parts/1 min, respectively, and the tube pumps A and B are driven when the temperature in the flask reaches 31.0° C.

### [Production of Comparative Toner Particle (C3)]

Comparative Toner Particle (C3) is obtained in the same manner as Toner Particle (1) except that in the production of Toner Particle (1), the liquid feed rate of the tube pump A and the liquid feed rate of the tube pump B are set to 0.90 parts/1 min and 0.14 parts/1 min, respectively, and the tube pumps A and B are driven when the temperature in the flask reached 39.0° C.

### [Production of Comparative Toner Particle (C4)]

Comparative Toner Particle (C4) is obtained in the same manner as Toner Particle (1) except that in the production of Toner Particle (1), the liquid feed rate of the tube pump A and the liquid feed rate of the tube pump B are set to 0.70 parts/1 min and 0.14 parts/1 min, respectively, and the tube pumps A and B are driven when the temperature in the flask reaches 41° C.

### [Production of Comparative Toner Particle (C5)]

Comparative Toner Particle (C5) is obtained in the same manner as Toner Particle (1) except that in the production of Toner Particle (1), the liquid feed rate of the tube pump A and the liquid feed rate of the tube pump B are set to 0.50 parts/1 min and 0.14 parts/1 min, respectively, and the tube pumps A and B are driven when the temperature in the flask reaches 34.0° C.

### <Production of Silica Particle>

### [Production of Silica Particle (1)]

After mixing SiCl₄, hydrogen gas and oxygen gas in a mixing chamber of a combustion burner, the mixed gas is burned at a temperature of 1,000° C. to 3,000° C., and a silica powder is taken out from the gas after burning to obtain a silica particle. At this time, the molar ratio of hydrogen gas and oxygen gas is set to 1.3:1, whereby Silica Particle (R1) having a volume average particle diameter of 136 nm is obtained.

100 Parts of Silica Particle (R1) obtained and 500 parts of ethanol are charged into an evaporator and stirred for 15 minutes while keeping the temperature at 40° C. Subsequently, 20 parts of hexamethyldisilazane (HMDS) is added per 100 parts of the silica particle, followed by stirring for 15 minutes. The temperature is finally raised to 90° C., and ethanol is dried under reduced pressure. The treated product is then taken out and further vacuum-dried at 120° C. for 30 minutes to obtain hexamethyldisilazane-treated Silica Particle (1) having a volume average particle diameter of 136 nm.

### [Production of Silica Particle (2)]

Silica Particle (2) having a volume average particle diameter of 82 nm is obtained using the same conditions and the same method as in the production of Silica Particle (1) except that the molar ratio of hydrogen gas and oxygen gas is set to 1.6:1.

### [Production of Silica Particle (3)]

Silica Particle (3) having a volume average particle diameter of 180 nm is obtained using the same conditions and the same method as in the production of Silica Particle (1) except that the molar ratio of hydrogen gas and oxygen gas is set to 1.2:1.

### [Production of Silica Particle (C1)]

Silica Particle (C1) having a volume average particle diameter of 64 nm is obtained using the same conditions and the same method as in the production of Silica Particle (1) except that the molar ratio of hydrogen gas and oxygen gas is set to 1.85:1.

### [Production of Silica Particle (C2)]

Silica Particle (C2) having a volume average particle diameter of 250 nm is obtained using the same conditions and the same method as in the production of Silica Particle (1) except that the molar ratio of hydrogen gas and oxygen gas is set to 1:1.

### Examples 1 to 9 and Comparative Examples 1 to 7

### Production of Toner

100 Parts of the toner particle of the type shown in Table 1 and the silica particle of the type and the amount (parts) shown in Table 1 are mixed using a Henschel mixer (peripheral velocity: 30 m/sec, 3 minutes) to obtain each toner.

### [Production of Developer]

Ferrite particle (average particle diameter: 50 μm): 100 parts

Toluene: 14 parts

Styrene/methyl methacrylate copolymer (copolymerization 3 parts ratio: 15/85):

Carbon black: 0.2 parts

These components except for the ferrite particle are dispersed by a sand mill to prepare a dispersion liquid, and this dispersion liquid was put in a vacuum deaeration-type kneader together with the ferrite particle, stirred while reducing the pressure, and dried to obtain a carrier.

Thereafter, 8 parts of each toner is mixed per 100 parts of the carrier above to obtain a developer.

### <Various Measurements>

With respect to the toner of the developer obtained in each of Examples and Comparative Examples, the mode value and skewness of the distribution of the eccentricity degree B of the release agent domain are measured according to the methods described above. The bulk density is also measured by the method described above. The results are shown in Table 1.

The silica particle of the toner of the developer obtained in each of Examples and Comparative Examples is measured for the volume average particle diameter (in the Table, “D50v”) by the method described above. The results are shown in Table 1.

### <Evaluation>

The following evaluations are performed using the developer obtained in each of Examples and Comparative Examples. The results are shown in Table 1.

The developer bottle of 700 Digital Color Press (“an apparatus having mounted therein a cleaning blade for cleaning the photoreceptor”, manufactured by Fuji Xerox Co., Ltd.) is filled with the developer obtained in each of Examples and Comparative Examples, and the following evaluations are carried out using this apparatus in an environment of ordinary temperature and ordinary humidity (temperature: 22° C., humidity: 55% RH).

### (Thermal Storability)

An entire-surface halftone image with an image density of 20% is continuously output on 20,000 sheets of C2 paper. Here, the output speed is set to 100 sheets/min. Thereafter, the developer is taken out from the developer bottle of the apparatus, and the thermal storability of the toner is evaluated by charging the toner weighed 2 g onto a sieve having an opening size of 45 μm by use of a powder tester (manufactured by Hosokawa Micron Corporation), applying vibration at a vibration width of 1 mm for 90 seconds, and measuring the weight of the toner on each sieve after vibration. The criteria for evaluation are as follows.

### —Criteria for Evaluation of Thermal Storability—

G1: The weight of the toner remaining on the sieve having an opening size of 45 μm is less than 0.4 g.
G2: The weight of the toner remaining on the sieve having an opening size of 45 μm is from 0.4 g to less than 0.8 g.
G3: The weight of the toner remaining on the sieve having an opening size of 45 μm is 0.8 g or more.

### (Evaluation of Ghost)

An image with an image density of 20% is continuously output on 100,000 sheets of C2 paper. Here, the output speed is set to 100 sheets/min. Thereafter, an image with an image density of 5% is output on one sheet of C2 paper. The non-image area of the image output is observed, and the ghost ascribable to escape of a silica particle from a cleaning blade is evaluated with an eye. The criteria for evaluation are as follows.

### —Criteria for Evaluation of Ghost—

G1: A level where generation of a ghost cannot be confirmed.
G2: A level where a ghost can be slightly confirmed.
G3: A level where a ghost can be clearly confirmed.

TABLE 1

| | Toner particle | | | | | | Toner | | |
|---|---|---|---|---|---|---|---|---|---|
| | | Distribution of Eccentricity Degree B of Release | | Silica Particle | | | Bulk | Evaluation | |
| | | Agent Domain | | | | D50v | Density | Thermal | |
| | No. | Mode Value | Skewness | No. | Parts | (nm) | (g/cm³) | Storability | Ghost |
| Example 1 | (1) | 0.88 | −0.80 | (1) | 2.0 | 136 | 0.37 | G1 | G1 |
| Example 2 | (2) | 0.76 | −0.79 | (1) | 2.0 | 136 | 0.34 | G2 | G2 |
| Example 3 | (3) | 0.85 | −0.52 | (1) | 2.0 | 136 | 0.36 | G1 | G2 |
| Example 4 | (1) | 0.88 | −0.80 | (2) | 2.0 | 82 | 0.38 | G2 | G1 |
| Example 5 | (1) | 0.88 | −0.80 | (3) | 2.0 | 180 | 0.35 | G2 | G2 |
| Example 6 | (4) | 0.97 | −0.79 | (1) | 2.0 | 136 | 0.37 | G2 | G1 |
| Example 7 | (5) | 0.89 | −1.07 | (1) | 2.0 | 136 | 0.35 | G2 | G1 |
| Example 8 | (1) | 0.88 | −0.80 | (1) | 3.8 | 136 | 0.39 | G1 | G2 |
| Example 9 | (1) | 0.88 | −0.80 | (1) | 1.1 | 136 | 0.33 | G2 | G1 |
| Comparative | (C1) | 0.68 | −0.42 | (1) | 2.0 | 136 | 0.32 | G3 | G3 |
| Example 1 | | | | | | | | | |
| Comparative | (C2) | 0.70 | −0.79 | (1) | 2.0 | 136 | 0.32 | G3 | G3 |
| Example 2 | | | | | | | | | |
| Comparative | (C3) | 0.90 | −0.42 | (1) | 2.0 | 136 | 0.37 | G1 | G3 |
| Example 3 | | | | | | | | | |
| Comparative | (1) | 0.88 | −0.80 | (C1) | 2.0 | 64 | 0.41 | G3 | G3 |
| Example 4 | | | | | | | | | |
| Comparative | (1) | 0.88 | −0.80 | (C2) | 2.0 | 250 | 0.33 | G2 | G3 |
| Example 5 | | | | | | | | | |
| Comparative | (C4) | 1.00 | −0.79 | (1) | 2.0 | 136 | 0.32 | G3 | G1 |
| Example 6 | | | | | | | | | |
| Comparative | (C5) | 0.89 | −1.16 | (1) | 2.0 | 136 | 0.33 | G3 | G1 |
| Example 7 | | | | | | | | | |

It is seen from the results above that in Examples of the present invention, both evaluations of thermal storability and ghost are good, compared with Comparative Examples.

### Examples 1B to 9B and Comparative Examples 1B to 4B

### Preparation of Resin Particle Dispersion Liquid

### [Preparation of Resin Particle Dispersion Liquid (1B)]

Terephthalic acid: 30 molar parts

Fumaric acid: 70 molar parts

Bisphenol A ethylene oxide adduct: 5 molar parts

Bisphenol A propylene oxide adduct: 95 molar parts

These materials are charged into a flask having an internal volume of 5 liter and being equipped with a stirring device, a nitrogen inlet tube, a temperature sensor and a rectifying column. The temperature is raised to 210° C. over 1 hour, and 1 part of titanium tetraethoxide is charged per 100 parts of the materials above. The temperature is raised to 230° C. over 0.5 hours while distilling out water produced and after continuing the dehydration condensation reaction for 1 hour at this temperature, the reaction product is cooled. In this way, Polyester Resin (1) having a weight average molecular weight of 18,500, an acid value of 14 mgKOH/g and a glass transition temperature of 59° C. is synthesized.

40 Parts of ethyl acetate and 25 parts of 2-butanol are charged into a vessel equipped with a temperature adjusting unit and a nitrogen purging unit to prepare a mixed solvent. Thereafter, 100 parts of Polyester Resin (1) is gradually charged and dissolved, and an aqueous 10 mass % ammonia solution (in an amount corresponding to 3 times, in terms of molar ratio, the acid value of the resin) is added thereto, followed by stirring for 30 minutes.

Subsequently, the inside of the vessel is purged with dry nitrogen, and 400 parts of ion-exchanged water is added dropwise at a rate of 2 parts/min by keeping the temperature at 40° C. while stirring the mixed solution, thereby effecting emulsification. After the completion of dropwise addition, the emulsified liquid is returned to room temperature (from 20° C. to 25° C.), and the content of ethyl acetate and 2-butanol is decreased to 1,000 ppm or less by bubbling dry nitrogen through the solution for 48 hours with stirring to obtain a resin particle dispersion liquid in which resin particles having a volume average particle diameter of 200 nm are dispersed. Ion-exchanged water is added to this resin particle dispersion liquid to adjust the solid content to 20 mass %, and the resulting dispersion liquid is designated as Resin Particle Dispersion Liquid (1B).

### <Preparation of Coloring Agent Particle Dispersion Liquid>

### [Preparation of Coloring Agent Particle Dispersion Liquid (1B)]

Cyan pigment, C.I. Pigment Blue 15:3 (copper 70 parts phthalocyanine, produced by DIC Corp., trade name: FASTOGEN BLUE LA5380):

Anionic surfactant (Neogen RK, produced by Dai-Ichi Kogyo Seiyaku Co., Ltd.): 5 parts

Ion-exchanged water: 200 parts

These materials are mixed and dispersed for 10 minutes by using a homogenizer (ULTRA-TURRAX T50, manufactured by IKA), and ion-exchanged water is added to adjust the solid content in the dispersion liquid to 20 mass %, whereby Coloring Agent Particle Dispersion Liquid (1B) wherein coloring agent particles with a volume average particle diameter of 190 nm are dispersed therein is obtained.

### <Preparation of Release Agent Particle Dispersion Liquid>

### [Preparation of Release Agent Particle Dispersion Liquid (1B)]

Paraffin wax (HNP-9, produced by Nippon Seiro Co., Ltd.): 100 parts

Anionic surfactant (Neogen RK, produced by Dai-Ichi Kogyo Seiyaku Co., Ltd.): 1 part

Ion-exchanged water: 350 parts

These materials are mixed, heated at 100° C., dispersed using a homogenizer (ULTRA-TURRAX T50, manufactured by IKA), and then subjected to a dispersion treatment by means of a Manton Gaulin high-pressure homogenizer (manufactured by Gaulin Corp.) to obtain Release Agent Particle Dispersion Liquid (1B) (solid content: 20 mass %) wherein release agent particles with a volume average particle diameter of 200 nm are dispersed therein.

### <Production of Toner Particle>

### [Production of Toner Particle (1B)]

An apparatus where a round stainless steel-made flask and a vessel A are connected by a tube pump A, a solution stored in the vessel A is fed to the flask by the drive of the tube pump A, the vessel A and a vessel B are connected by a tube pump B, and a solution stored in the vessel B is fed to the vessel A by the drive of the tube pump B, is prepared (see, FIG. 3). The following operation is carried out by using this apparatus.

Resin Particle Dispersion Liquid (1B): 500 parts

Coloring Agent Particle Dispersion Liquid (1): 40 parts

Anionic surfactant (TaycaPower): 2 parts

These materials are put in the round stainless steel-made flask and after adjusting the pH to 3.5 by adding 0.1 N nitric acid, 30 parts of an aqueous nitric acid solution having a polyaluminum chloride concentration of 10 mass % is added. Subsequently, the mixture is dispersed at 30° C. by using a homogenizer (ULTRA-TURRAX T50, manufactured by IKA), and thereafter, the temperature is raised at a rate of 1° C./30 min in an oil bath for heating to grow the particle diameter of aggregate particles.

On the other hand, 150 parts of Resin Particle Dispersion Liquid (1B) is put in the vessel A that is a polyester-made bottle, and 25 parts of Release Agent Particle Dispersion Liquid (1B) is put in the vessel B. Then, the liquid feed rate of the tube pump A and the liquid feed rate of the tube pump B are set to 0.7 parts/1 min and 0.14 parts/1 min, respectively, and when the temperature in the round stainless steel-made flask under the formation of aggregate particles reaches 37.0° C., the tube pumps A and B are driven to start feed of respective dispersion liquids, whereby a mixed dispersion liquid having dispersed therein a resin particle and a release agent particle is fed from the vessel A to the round stainless steel-made flask under the formation of aggregate particles while gradually increasing the concentration of the release agent particle.

The resulting mixture is held for 30 minutes from the time when feed of respective dispersion liquids to the flask is completed and the temperature in the flask reaches 48° C., and a second aggregate particle is thereby formed.

Thereafter, 50 parts of Resin Particle Dispersion Liquid (1B) is slowly added, and the mixture is held for 1 hour. After adjusting the pH to 8.5 by adding an aqueous 0.1 N sodium hydroxide solution, the mixture is heated to 85° C. while continuously stirring, held for 5 hours, then cooled to 20° C. at a rate of 20° C./min, filtered, thoroughly washed with ion-exchanged water, and dried to obtain Toner Particle (1B) having a volume average particle diameter of 6.0 μm.

### [Production of Toner Particle (2B)]

Toner Particle (2B) is obtained in the same manner as Toner Particle (1B) except that in the production of Toner Particle (1B), the liquid feed rate of the tube pump A and the liquid feed rate of the tube pump B are set to 0.56 parts/1 min and 0.11 parts/1 min, respectively, and the tube pumps A and B are driven when the temperature in the flask reaches 32.1° C.

### [Production of Toner Particle (3B)]

Toner Particle (3B) is obtained in the same manner as Toner Particle (1B) except that in the production of Toner Particle (1B), the liquid feed rate of the tube pump A and the liquid feed rate of the tube pump B are set to 0.68 parts/1 min and 0.15 parts/1 min, respectively, and the tube pumps A and B are driven when the temperature in the flask reaches 33.8° C.

### [Production of Toner Particle (4B)]

Toner Particle (4B) is obtained in the same manner as Toner Particle (1B) except that in the production of Toner Particle (1B), the liquid feed rate of the tube pump A and the liquid feed rate of the tube pump B are set to 0.82 parts/1 min and 0.17 parts/1 min, respectively, and the tube pumps A and B are driven when the temperature in the flask reaches 39.4° C.

### [Production of Comparative Toner Particle (C1B)]

Comparative Toner Particle (C1B) is obtained in the same manner as Toner Particle (1B) except that in the production of Toner Particle (1B), the liquid feed rate of the tube pump A and the liquid feed rate of the tube pump B are set to 0.79 parts/1 min and 0.11 parts/1 min, respectively, and the tube pumps A and B are driven when the temperature in the flask reaches 30.6° C.

### [Production of Comparative Toner Particle (C2B)]

Comparative Toner Particle (C2B) is obtained in the same manner as Toner Particle (1B) except that in the production of Toner Particle (1B), the liquid feed rate of the tube pump A and the liquid feed rate of the tube pump B are set to 0.49 parts/1 min and 0.10 parts/1 min, respectively, and the tube pumps A and B are driven when the temperature in the flask reaches 30.2° C.

### [Production of Comparative Toner Particle (C3B)]

Comparative Toner Particle (C3B) is obtained in the same manner as Toner Particle (1B) except that in the production of Toner Particle (1B), the liquid feed rate of the tube pump A and the liquid feed rate of the tube pump B are set to 1.02 parts/1 min and 0.19 parts/1 min, respectively, and the tube pumps A and B are driven when the temperature in the flask reaches 39.4° C.

### <Production of Surface-Treated Silica Particle>

### [Production of Oil-Treated Silica Particle (1B)]

After mixing SiCl₄, hydrogen gas and oxygen gas in a mixing chamber of a combustion burner, the mixed gas is burned at a temperature of 1,000° C. to 3,000° C., and a silica powder is taken out from the gas after burning to obtain a silica particle. At this time, the molar ratio of hydrogen gas and oxygen gas is set to 1.3:1, whereby Silica Particle (R1) having a volume average particle diameter of 136 nm is obtained.

100 Parts of Silica Particle (R1) and 500 parts of ethanol are charged into an evaporator and stirred for 15 minutes while keeping the temperature at 40° C. Subsequently, 10 parts of dimethylsilicone oil is added per 100 parts of the silica particle, followed by stirring for 15 minutes, and furthermore, 10 parts of dimethylsilicone oil is added per 100 parts of the silica particle, followed by stirring for 15 minutes. The temperature is finally raised to 90° C., and ethanol is dried under reduced pressure. The treated product is then taken out and further vacuum-dried at 120° C. for 30 minutes to obtain Oil-Treated Silica Particle (1B) having a volume average particle diameter of 136 nm and a free oil amount of 10 mass %.

### [Production of Oil-Treated Silica Particle (2B)]

Oil-Treated Silica Particle (2B) having a volume average particle diameter of 180 nm and a free oil amount of 10 mass % is obtained using the same conditions and the same method as in the production of Oil-Treated Silica Particle (1B) except that the molar ratio of hydrogen gas and oxygen gas is set to 1.2:1.

### [Production of Oil-Treated Silica Particle (3B)]

Oil-Treated Silica Particle (3B) having a volume average particle diameter of 32 nm and a free oil amount of 10 mass % is obtained using the same conditions and the same method as in the production of Oil-Treated Silica Particle (1B) except that the molar ratio of hydrogen gas and oxygen gas is set to 1.5:1.

### [Production of Oil-Treated Silica Particle (4B)]

100 Parts of Silica Particle (R1) used in the production of Oil-Treated Silica Particle (1B) and 500 parts of ethanol are charged into an evaporator and stirred for 15 minutes while keeping the temperature at 40° C. Subsequently, 6 parts of dimethylsilicone oil is added per 100 parts of the silica particle, followed by stirring for 15 minutes. The temperature is finally raised to 90° C., and ethanol is dried under reduced pressure. The treated product is then taken out and further vacuum-dried at 120° C. for 30 minutes to obtain Oil-Treated Silica Particle (4B) having a volume average particle diameter of 136 nm and a free oil amount of 3 mass %.

### [Production of HMDS-Treated Silica Particle (C1B)]

100 Parts of Silica Particle (R1) used in the production of Oil-Treated Silica Particle (1B) and 500 parts of ethanol are charged into an evaporator and stirred for 15 minutes while keeping the temperature at 40° C. Subsequently, 20 parts of hexamethyldisilazane (HMDS) is added per 100 parts of the silica particle, followed by stirring for 15 minutes. The temperature is finally raised to 90° C., and ethanol is dried under reduced pressure. The treated product is then taken out and further vacuum-dried at 120° C. for 30 minutes to obtain HMDS-Treated Silica Particle (C1B) treated with hexamethyldisilazane and having a volume average particle diameter of 136 nm.

### Examples 1B to 7B and Comparative Examples 1B to 4B

### Production of Toner

100 Parts of the toner particle of the type shown in Table 2 and the surface-treated silica particle of the type and the amount (parts) shown in Table 2 are mixed using a Henschel mixer (peripheral velocity: 30 m/sec, 3 minutes) to obtain each toner.

### [Production of Developer]

Ferrite particle (average particle diameter: 50 μm): 100 parts

Toluene: 14 parts

Styrene/methyl methacrylate copolymer (copolymerization 3 parts ratio: 15/85):

Carbon black: 0.2 parts

These components except for the ferrite particle are dispersed by a sand mill to prepare a dispersion liquid, and this dispersion liquid is put in a vacuum deaeration-type kneader together with the ferrite particle, stirred while reducing the pressure, and dried to obtain a carrier.

Thereafter, 8 parts of each toner is mixed per 100 parts of the carrier above to obtain a developer.

### <Various Measurements>

With respect to the toner of the developer obtained in each of Examples and Comparative Examples, the mode value and skewness of the distribution of the eccentricity degree B of the release agent domain are measured according to the methods described above. The results are shown in Table 2.

The oil-treated silica particle of the toner of the developer obtained in each of Examples and Comparative Examples is measured for the volume average particle diameter (in the Table, “D50v”) and free oil amount by the method described above. The results are shown in Table 2.

### <Evaluation>

The following evaluations are performed using the developer obtained in each of Examples and Comparative Examples. The results are shown in Table 2.

The developer obtained in each of Examples and Comparative Examples is left standing for 3 days in a low-temperature low-humidity (temperature: 10° C., humidity: 15% RH) environment. The developer bottle of 700 Digital Color Press (manufactured by Fuji Xerox Co., Ltd.) is filled with the developer, and the following evaluations are carried out using this apparatus in a low-temperature low-humidity (temperature: 10° C., humidity: 15% RH) environment.

First, a 100% solid image patch of 5 cm×5 cm is formed on C2 paper produced by Fuji Xerox Co., Ltd. The density of the formed patch is measured and designated as Density 1. Here, the density was measured by an image densitometer X-Rite 938 (manufactured by X-Rite Inc.).

Then, an image with an image density of 40% is continuously output on 100,000 sheets of C2 paper. The density in the background part output on 100,000th sheet is measured in the same manner as Density 1. The density is also confirmed with an eye. The measured density is evaluated as the fogging density.

Next, an image with an image density of 1% is continuously output on 100,000 sheets of C2 paper. Thereafter, a 100% solid image patch of 5 cm×5 cm is formed, and the density of this patch is measured in the same manner as Density 1 and designated as Density 2.

The evaluation according to the following criteria is performed based on the fogging density and observation with an eye. The allowable range is from G1 to G3.

### —Criteria for Evaluation of Fogging—

G1: The fogging density is less than 0.2 and partial fogging is not observed with an eye.
G2: The fogging density is less than 0.2 but slight fogging is observed with an eye.
G3: The fogging density is less than 0.2 but partial fogging is observed with an eye.
G4: The fogging density is 0.2 or more.

The difference between Density 2 and Density 1 is determined and designated as ΔDensity, i.e., ΔDensity=Density 2−Density 1. The allowable range is from G1 to G3.

### —Criteria for Evaluation of Density Reduction—

### G1: 0<ΔDensity≦0.2

### G2: 0.2<ΔDensity≦0.3

### G3: 0.3<ΔDensity

TABLE 2

| | Toner particle | | | Surface-Treated Silica Particle | | | | | |
|---|---|---|---|---|---|---|---|---|---|
| | | Distribution of Eccentricity Degree B of Release | | | | | Free Oil | | |
| | | Agent Domain | | | | D50v | Amount | Evaluation | |
| | No. | Mode Value | Skewness | No. | Parts | (nm) | (mass %) | Fogging | Image Density |
| Example 1B | (1B) | 0.85 | −0.80 | (1B) | 1.50 | 136 | 10 | G1 | G2 |
| Example 2B | (2B) | 0.78 | −1.05 | (1B) | 1.50 | 136 | 10 | G2 | G1 |
| Example 3B | (3B) | 0.78 | −0.82 | (1B) | 1.50 | 136 | 10 | G1 | G2 |
| Example 4B | (4B) | 0.92 | −0.58 | (1B) | 1.50 | 136 | 10 | G1 | G2 |
| Example 5B | (1B) | 0.85 | −0.80 | (2B) | 1.50 | 180 | 10 | G2 | G1 |
| Example 6B | (1B) | 0.85 | −0.80 | (3B) | 1.50 | 32 | 10 | G2 | G2 |
| Example 7B | (1B) | 0.85 | −0.80 | (4B) | 1.50 | 136 | 3 | G2 | G2 |
| Comparative | | | | | | | HMDS | | |
| Example 1B | (1B) | 0.85 | −0.80 | (C1B) | 1.50 | 136 | treatment | G2 | G3 |
| Comparative | (C1B) | 0.65 | −0.62 | (1B) | 1.50 | 136 | 10 | G4 | G1 |
| Example 2B | | | | | | | | | |
| Comparative | (C2B) | 0.76 | −1.18 | (1B) | 1.50 | 136 | 10 | G3 | G2 |
| Example 3B | | | | | | | | | |
| Comparative | (C3B) | 0.88 | −0.20 | (1B) | 1.50 | 136 | 10 | G1 | G3 |
| Example 4B | | | | | | | | | |

It is seen from the results above that in Examples of the present invention, both evaluations of fogging and image density are good, compared with Comparative Examples.

### Examples 1C to 8C and Comparative Examples 1C to 5C

### Preparation of Resin Particle Dispersion Liquid

### [Preparation of Resin Particle Dispersion Liquid (1C)]

Terephthalic acid: 30 molar parts

Fumaric acid: 70 molar parts

Bisphenol A ethylene oxide adduct: 5 molar parts

Bisphenol A propylene oxide adduct: 95 molar parts

These materials are charged into a flask having an internal volume of 5 liter and being equipped with a stirring device, a nitrogen inlet tube, a temperature sensor and a rectifying column. The temperature is raised to 210° C. over 1 hour, and 1 part of titanium tetraethoxide is charged per 100 parts of the materials above. The temperature is raised to 230° C. over 0.5 hours while distilling out water produced and after continuing the dehydration condensation reaction for 1 hour at this temperature, the reaction product is cooled. In this way, Polyester Resin (1) having a weight average molecular weight of 18,500, an acid value of 14 mgKOH/g and a glass transition temperature of 59° C. is synthesized.

40 Parts of ethyl acetate and 25 parts of 2-butanol are charged into a vessel equipped with a temperature adjusting unit and a nitrogen purging unit to prepare a mixed solvent. Thereafter, 100 parts of Polyester Resin (1) is gradually charged and dissolved, and an aqueous 10 mass % ammonia solution (in an amount corresponding to 3 times, in terms of molar ratio, the acid value of the resin) is added thereto, followed by stirring for 30 minutes.

Subsequently, the inside of the vessel is purged with dry nitrogen, and 400 parts of ion-exchanged water is added dropwise at a rate of 2 parts/min by keeping the temperature at 40° C. while stirring the mixed solution, thereby effecting emulsification. After the completion of dropwise addition, the emulsified liquid is returned to room temperature (from 20° C. to 25° C.), and the content of ethyl acetate and 2-butanol is decreased to 1,000 ppm or less by bubbling dry nitrogen through the solution for 48 hours with stirring to obtain a resin particle dispersion liquid in which resin particles having a volume average particle diameter of 200 nm are dispersed. Ion-exchanged water is added to this resin particle dispersion liquid to adjust the solid content to 20 mass %, and the resulting dispersion liquid is designated as Resin Particle Dispersion Liquid (1C).

### <Preparation of Coloring Agent Particle Dispersion Liquid>

### [Preparation of Coloring Agent Particle Dispersion Liquid (1C)]

Cyan pigment, C.I. Pigment Blue 15:3 (copper 70 parts phthalocyanine, produced by DIC Corp., trade name: FASTOGEN BLUE LA5380):

Anionic surfactant (Neogen RK, produced by Dai-Ichi Kogyo Seiyaku Co., Ltd.): 5 parts

Ion-exchanged water: 200 parts

These materials are mixed and dispersed for 10 minutes by using a homogenizer (ULTRA-TURRAX T50, manufactured by IKA), and ion-exchanged water is added to adjust the solid content in the dispersion liquid to 20 mass %, whereby Coloring Agent Particle Dispersion Liquid (1C) wherein coloring agent particles with a volume average particle diameter of 190 nm are dispersed therein is obtained.

### <Preparation of Release Agent Particle Dispersion Liquid>

### [Preparation of Release Agent Particle Dispersion Liquid (1C)]

Paraffin wax (HNP-9, produced by Nippon Seiro Co., Ltd.): 100 parts

Anionic surfactant (Neogen RK, produced by Dai-Ichi Kogyo Seiyaku Co., Ltd.): 1 part

Ion-exchanged water: 350 parts

These materials are mixed, heated at 100° C., dispersed using a homogenizer (ULTRA-TURRAX T50, manufactured by IKA), and then subjected to a dispersion treatment by means of a Manton Gaulin high-pressure homogenizer (manufactured by Gaulin Corp.) to obtain Release Agent Particle Dispersion Liquid (1C) (solid content: 20 mass %) wherein release agent particles with a volume average particle diameter of 200 nm are dispersed therein.

### <Production of External Additive>

### [Preparation of Strontium Titanate Particle]

Strontium chloride in an amount equimolar to the amount of titanium oxide is added to a metatitanic acid slurry. Thereafter, carbonic acid gas in a molar amount two times the amount of titanium oxide is blown at a flow rate of 1 L/min and at the same time, aqueous ammonia is added. At this time, the pH value is 8. The precipitate is washed with water, dried at 110° C. for 24 hours, sintered at 800° C., mechanically pulverized, and classified to produce Strontium Titanate Particle (1C) having a number average particle diameter of 5.0 μm.

Strontium Titanate Particle (2C) having a number average particle diameter of 3.2 μm and Strontium Titanate Particle (3C) having a number average particle diameter of 6.9 μm are obtained by adjusting pulverization conditions and classification conditions in the production of Strontium Titanate Particle (1C).

### [Preparation of Cerium Oxide Particle (1C)]

350 Parts of concentrated nitric acid is added to 50 parts of cerium hydroxide and dissolved under heating, and the solution after dissolution is diluted with water to make 500 parts. This aqueous nitric acid solution is extracted for 3 minutes with 1,000 parts of kerosene containing 10% of tributylphosphoric acid (TBP). After the extraction, the organic phase and the aqueous phase are separated. The organic phase is washed by adding 500 parts of an aqueous 8.5 N nitric acid solution, and the resulting organic phase is separated and reverse-extracted with 100,000 parts of an aqueous solution containing 6,000 parts of aqueous 35% hydrogen peroxide. The aqueous phase is then separated, and the residue is added with aqueous ammonia, recovered as cerium hydroxide and fired at 700° C. to produce Cerium Oxide Particle (1C) having a number average particle diameter of 5.5 μm.

### Example 1C

### Preparation of Toner Particle

An apparatus where a round stainless steel-made flask and a vessel A are connected by a tube pump A, a solution stored in the vessel A is fed to the flask by the drive of the tube pump A, the vessel A and a vessel B are connected by a tube pump B, and a solution stored in the vessel B is fed to the vessel A by the drive of the tube pump B, is prepared (see, FIG. 3). The following operation is carried out by using this apparatus.

Resin Particle Dispersion Liquid (1C): 500 parts

Coloring Agent Particle Dispersion Liquid (1C): 40 parts

Anionic surfactant (TaycaPower): 2 parts

These materials are put in the round stainless steel-made flask and after adjusting the pH to 3.5 by adding 0.1 N nitric acid, 30 parts of an aqueous nitric acid solution having a polyaluminum chloride concentration of 10 mass % is added. Subsequently, the mixture is dispersed at 30° C. by using a homogenizer (ULTRA-TURRAX T50, manufactured by IKA), and thereafter, the temperature is raised at a rate of 1° C./30 min in an oil bath for heating to grow the particle diameter of aggregate particles.

On the other hand, 150 parts of Resin Particle Dispersion Liquid (1C) is put in the vessel A that is a polyester-made bottle, and 25 parts of Release Agent Particle Dispersion Liquid (1C) is put in the vessel B. Then, the liquid feed rate of the tube pump A and the liquid feed rate of the tube pump B are set to 0.70 parts/1 min and 0.14 parts/1 min, respectively, and when the temperature in the round stainless steel-made flask under the formation of aggregate particles reaches 37.0° C., the tube pumps A and B are driven to start feed of respective dispersion liquids, whereby a mixed dispersion liquid having dispersed therein a resin particle and a release agent particle is fed from the vessel A to the round stainless steel-made flask under the formation of aggregate particles while gradually increasing the concentration of the release agent particle.

The resulting mixture is held for 30 minutes from the time when feed of respective dispersion liquids to the flask is completed and the temperature in the flask reaches 48° C., and a second aggregate particle is thereby formed.

Thereafter, 50 parts of Resin Particle Dispersion Liquid (1C) is slowly added, and the mixture is held for 1 hour. After adjusting the pH to 8.5 by adding an aqueous 0.1 N sodium hydroxide solution, the mixture is heated to 85° C. while continuously stirring, held for 5 hours, then cooled to 20° C. at a rate of 20° C./min, filtered, thoroughly washed with ion-exchanged water, and dried to obtain Toner Particle (1C) having a volume average particle diameter of 6.0

### [Preparation of Toner]

100 Parts of Toner Particle (1C), 0.7 parts of dimethylsilicone oil-treated silica particle (RY200, produced by Nippon Aerosil Co., Ltd.) and 0.2 parts of Strontium Titanate Particle (1C) are mixed using a Henschel mixer (peripheral velocity: 30 msec, 3 minutes) to obtain Toner (1C).

### [Preparation of Developer]

Ferrite particle (average particle diameter: 50 μm): 100 parts

Toluene: 14 parts

Styrene/methyl methacrylate copolymer (copolymerization 3 parts ratio: 15/85):

Carbon black: 0.2 parts

These components except for the ferrite particle are dispersed by a sand mill to prepare a dispersion liquid, and this dispersion liquid is put in a vacuum deaeration-type kneader together with the ferrite particle, stirred while reducing the pressure, and dried to obtain a carrier.

Thereafter, 8 parts of Toner (1C) is mixed per 100 parts of the carrier above to obtain Developer (1C).

### Example 2C

Toner Particle (2C) is obtained in the same manner as in Example 1C except that in the preparation of Toner Particle (1C), the liquid feed rate of the tube pump A and the liquid feed rate of the tube pump B are set to 0.75 parts/1 min and 0.14 parts/1 min, respectively, and the tube pumps A and B are driven when the temperature in the flask reaches 32.0° C. Toner Particle (2C) obtained has a volume average particle diameter of 5.9 μm. Toner (2C) and Developer (2C) are obtained in the same manner as in Example 1C by using Toner Particle (2C).

### Example 3C

Toner Particle (3C) is obtained in the same manner as in Example 1C except that in the preparation of Toner Particle (1C), the liquid feed rate of the tube pump A and the liquid feed rate of the tube pump B are set to 0.7 parts/1 min and 0.14 parts/1 min, respectively, and the tube pumps A and B are driven when the temperature in the flask reaches 39.0° C. Toner Particle (3C) obtained has a volume average particle diameter of 5.3 μm. Toner (3C) and Developer (3C) are obtained in the same manner as in Example 1C by using Toner Particle (3C).

### Example 4C

Toner Particle (4C) is obtained in the same manner as in Example 1C except that in the preparation of Toner Particle (1C), the liquid feed rate of the tube pump A and the liquid feed rate of the tube pump B are set to 0.85 parts/1 min and 0.14 parts/1 min, respectively, and the tube pumps A and B are driven when the temperature in the flask reaches 36.0° C. Toner Particle (4C) obtained has a volume average particle diameter of 5.6 μm. Toner (4C) and Developer (4C) are obtained in the same manner as in Example 1C by using Toner Particle (4C).

### Example 5C

Toner Particle (5C) is obtained in the same manner as in Example 1C except that in the preparation of Toner Particle (1C), the liquid feed rate of the tube pump A and the liquid feed rate of the tube pump B are set to 0.55 parts/1 min and 0.14 parts/1 min, respectively, and the tube pumps A and B are driven when the temperature in the flask reaches 37.0° C. Toner Particle (5C) obtained has a volume average particle diameter of 5.7 μm. Toner (5C) and Developer (5C) are obtained in the same manner as in Example 1C by using Toner Particle (5C).

### Example 6C

Toner (6C) is obtained in the same manner as in Example 1C except that in the preparation of Toner (1C), Cerium Oxide Particle (1C) is used in place of Strontium Titanate Particle (1C). Developer (6C) is obtained in the same manner as in Example 1C by using Toner (6C).

### Example 7C

Toner (7C) is obtained in the same manner as in Example 1C except that in the preparation of Toner (1C), Strontium Titanate Particle (2C) is used in place of Strontium Titanate Particle (1C). Developer (7C) is obtained in the same manner as in Example 1C by using Toner (7C).

### Example 8C

Toner (8C) is obtained in the same manner as in Example 1C except that in the preparation of Toner (1C), Strontium Titanate Particle (3C) is used in place of Strontium Titanate Particle (1C). Developer (8C) is obtained in the same manner as in Example 1C by using Toner (8C).

### Comparative Example 1C

Toner (C1C) is obtained in the same manner as in Example 1C except that in the preparation of Toner (1C), Strontium Titanate Particle (1C) is not used. Developer (C1C) is obtained in the same manner as in Example 1C by using Toner (C1C).

### Comparative Example 2C

Toner Particle (C2C) is obtained in the same manner as in Example 1C except that in the preparation of Toner Particle (1C), the liquid feed rate of the tube pump A and the liquid feed rate of the tube pump B are set to 0.7 parts/1 min and 0.14 parts/1 min, respectively, and the tube pumps A and B are driven when the temperature in the flask reaches 29.0° C. Toner Particle (C2C) obtained has a volume average particle diameter of 6.0 μm. Toner (C2C) and Developer (C2C) are obtained in the same manner as in Example 1C by using Toner Particle (C2C).

### Comparative Example 3C

Toner Particle (C3C) is obtained in the same manner as in Example 1C except that in the preparation of Toner Particle (1C), the liquid feed rate of the tube pump A and the liquid feed rate of the tube pump B are set to 0.75 parts/1 min and 0.14 parts/1 min, respectively, and the tube pumps A and B are driven when the temperature in the flask reaches 40.0° C. Toner Particle (C3C) obtained has a volume average particle diameter of 5.9 μm. Toner (C3C) and Developer (C3C) are obtained in the same manner as in Example 1C by using Toner Particle (C3C).

### Comparative Example 4C

Toner Particle (C4C) is obtained in the same manner as in Example 1C except that in the preparation of Toner Particle (1C), the liquid feed rate of the tube pump A and the liquid feed rate of the tube pump B are set to 0.9 parts/1 min and 0.14 parts/1 min, respectively, and the tube pumps A and B are driven when the temperature in the flask reaches 36.0° C. Toner Particle (C4C) obtained has a volume average particle diameter of 6.1 μm. Toner (C4C) and Developer (C4C) are obtained in the same manner as in Example 1C by using Toner Particle (C4C).

### Comparative Example 5C

Toner Particle (C5C) is obtained in the same manner as in Example 1C except that in the preparation of Toner Particle (1C), the liquid feed rate of the tube pump A and the liquid feed rate of the tube pump B are set to 0.50 parts/1 min and 0.14 parts/1 min, respectively, and the tube pumps A and B are driven when the temperature in the flask reaches 37.0° C. Toner Particle (C5C) obtained has a volume average particle diameter of 5.4 μm. Toner (C5C) and Developer (C5C) are obtained in the same manner as in Example 1C by using Toner Particle (C5C).

### <Various Measurements>

With respect to the toner of the developer obtained in each of Examples and Comparative Examples, the mode value and skewness of the distribution of the eccentricity degree B of the release agent domain are measured according to the methods described above. The results are shown in Table 3.

### <Evaluation>

### —Evaluation of Color Streak—

The developer bottle of 700 Digital Color Press (manufactured by Fuji Xerox Co., Ltd.) is filled with the developer obtained in each of Examples and Comparative Examples, and a 100% solid image and a solid image with an image density (area coverage) of 50% are continuously output on a total of 100,000 sheets of plain paper in a high-temperature high-humidity environment (30° C., 85% RH).

With regard to the image output on 100 sheets from 99,901st sheet to 100,000th sheet, the presence or absence of generation of a color streak is observed with an eye, and the number of sheets where a color streak is generated is counted. The results are shown in Table 3.

G1: A color streak was not generated.
G2: The number of sheets where a color streak was generated is 5 or less.
G3: The number of sheets where a color streak was generated is from 6 to 10.
G4: The number of sheets where a color streak was generated is 11 or more.

TABLE 3

| | Toner Particle | | | | | | |
|---|---|---|---|---|---|---|---|
| | | Distribution of | | | | | |
| | | Eccentricity Degree | | External Additive Particle | | | |
| | | B of Release Agent | | | Particle | | |
| | | | Skew- | | Diameter | Content | Evaluation of |
| | No. | Mode Value | ness | Type | μm | mass % | Color Streak |
| Example 1C | 1C | 0.88 | −0.80 | SrTiO₃ | 5.0 | 0.2 | G1 |
| Example 2C | 2C | 0.78 | −0.70 | SrTiO₃ | 5.0 | 0.2 | G2 |
| Example 3C | 3C | 0.94 | −0.82 | SrTiO₃ | 5.0 | 0.2 | G2 |
| Example 4C | 4C | 0.86 | −0.54 | SrTiO₃ | 5.0 | 0.2 | G2 |
| Example 5C | 5C | 0.85 | −1.05 | SrTiO₃ | 5.0 | 0.2 | G2 |
| Example 6C | 6C | 0.88 | −0.80 | CeO₂ | 5.5 | 0.2 | G1 |
| Example 7C | 7C | 0.88 | −0.80 | SrTiO₃ | 3.2 | 0.2 | G2 |
| Example 8C | 8C | 0.88 | −0.80 | SrTiO₃ | 6.9 | 0.2 | G2 |
| Comparative | C1C | 0.88 | −0.80 | | | none | G4 |
| Example 1C | | | | | | | |
| Comparative | C2C | 0.70 | −0.78 | SrTiO₃ | 5.0 | 0.2 | G3 |
| Example 2C | | | | | | | |
| Comparative | C3C | 0.99 | −0.73 | SrTiO₃ | 5.0 | 0.2 | G3 |
| Example 3C | | | | | | | |
| Comparative | C4C | 0.85 | −0.44 | SrTiO₃ | 5.0 | 0.2 | G3 |
| Example 4C | | | | | | | |
| Comparative | C5C | 0.84 | −1.16 | SrTiO₃ | 5.0 | 0.2 | G3 |
| Example 5C | | | | | | | |

In Table 3, “SrTiO₃” indicates strontium titanate, “CeO₂” indicates cerium oxide, and “Particle Diameter” indicates the number average particle diameter.

It is seen from the results above that in Examples of the present invention, the evaluation of a color streak at the time of continuous printing in a high-temperature high-humidity environment is good, compared with Comparative Examples.

### Examples 1D to 6D and Comparative Examples 1D to 4D

### Preparation of Resin Particle Dispersion Liquid

### [Preparation of Resin Particle Dispersion Liquid (1D)]

Terephthalic acid: 30 molar parts

Fumaric acid: 70 molar parts

Bisphenol A ethylene oxide adduct: 5 molar parts

Bisphenol A propylene oxide adduct: 95 molar parts

These materials are charged into a flask having an internal volume of 5 liter and being equipped with a stirring device, a nitrogen inlet tube, a temperature sensor and a rectifying column. The temperature is raised to 210° C. over 1 hour, and 1 part of titanium tetraethoxide is charged per 100 parts of the materials above. The temperature is raised to 230° C. over 0.5 hours while distilling out water produced and after continuing the dehydration condensation reaction for 1 hour at this temperature, the reaction product is cooled. In this way, Polyester Resin (1) having a weight average molecular weight of 18,500, an acid value of 14 mgKOH/g and a glass transition temperature of 59° C. is synthesized.

40 Parts of ethyl acetate and 25 parts of 2-butanol are charged into a vessel equipped with a temperature adjusting unit and a nitrogen purging unit to prepare a mixed solvent. Thereafter, 100 parts of Polyester Resin (1) is gradually charged and dissolved, and an aqueous 10 mass % ammonia solution (in an amount corresponding to 3 times, in terms of molar ratio, the acid value of the resin) is added thereto, followed by stirring for 30 minutes.

Subsequently, the inside of the vessel is purged with dry nitrogen, and 400 parts of ion-exchanged water is added dropwise at a rate of 2 parts/min by keeping the temperature at 40° C. while stirring the mixed solution, thereby effecting emulsification. After the completion of dropwise addition, the emulsified liquid is returned to room temperature (from 20° C. to 25° C.), and the content of ethyl acetate and 2-butanol is decreased to 1,000 ppm or less by bubbling dry nitrogen through the solution for 48 hours with stirring to obtain a resin particle dispersion liquid in which resin particles having a volume average particle diameter of 200 nm are dispersed. Ion-exchanged water is added to this resin particle dispersion liquid to adjust the solid content to 20 mass %, and the resulting dispersion liquid is designated as Resin Particle Dispersion Liquid (1D).

### <Preparation of Coloring Agent Particle Dispersion Liquid>

### [Preparation of Coloring Agent Particle Dispersion Liquid (1D)]

Cyan pigment, C.I. Pigment Blue 15:3 (copper 70 parts phthalocyanine, produced by DIC Corp., trade name: FASTOGEN BLUE LA5380):

Anionic surfactant (Neogen RK, produced by Dai-Ichi Kogyo Seiyaku Co., Ltd.): 5 parts

Ion-exchanged water: 200 parts

These materials are mixed and dispersed for 10 minutes by using a homogenizer (ULTRA-TURRAX T50, manufactured by IKA), and ion-exchanged water is added to adjust the solid content in the dispersion liquid to 20 mass %, whereby Coloring Agent Particle Dispersion Liquid (1D) wherein coloring agent particles with a volume average particle diameter of 190 nm are dispersed therein is obtained.

### <Preparation of Release Agent Particle Dispersion Liquid>

### [Preparation of Release Agent Particle Dispersion Liquid (1D)]

Paraffin wax (HNP-9, produced by Nippon Seiro Co., Ltd.): 100 parts

Anionic surfactant (Neogen RK, produced by Dai-Ichi Kogyo Seiyaku Co., Ltd.): 1 part

Ion-exchanged water: 350 parts

These materials are mixed, heated at 100° C., dispersed using a homogenizer (ULTRA-TURRAX T50, manufactured by IKA), and then subjected to a dispersion treatment by means of a Manton Gaulin high-pressure homogenizer (manufactured by Gaulin Corp.) to obtain Release Agent Particle Dispersion Liquid (1D) (solid content: 20 mass %) wherein release agent particles with a volume average particle diameter of 200 nm are dispersed therein.

### <Production of Toner Particle>

### [Production of Toner Particle (1D)]

An apparatus where a round stainless steel-made flask and a vessel A are connected by a tube pump A, a solution stored in the vessel A is fed to the flask by the drive of the tube pump A, the vessel A and a vessel B are connected by a tube pump B, and a solution stored in the vessel B is fed to the vessel A by the drive of the tube pump B, is prepared (see, FIG. 3). The following operation is carried out by using this apparatus.

Resin Particle Dispersion Liquid (1D): 500 parts

Coloring Agent Particle Dispersion Liquid (1D): 40 parts

Anionic surfactant (TaycaPower): 2 parts

These materials are put in the round stainless steel-made flask and after adjusting the pH to 3.5 by adding 0.1 N nitric acid, 30 parts of an aqueous nitric acid solution having a polyaluminum chloride concentration of 10 mass % is added. Subsequently, the mixture is dispersed at 30° C. by using a homogenizer (ULTRA-TURRAX T50, manufactured by IKA), and thereafter, the temperature is raised at a rate of 1° C./30 min in an oil bath for heating to grow the particle diameter of aggregate particles.

On the other hand, 150 parts of Resin Particle Dispersion Liquid (1D) is put in the vessel A that is a polyester-made bottle, and 25 parts of Release Agent Particle Dispersion Liquid (1D) is put in the vessel B. Then, the liquid feed rate of the tube pump A and the liquid feed rate of the tube pump B are set to 0.7 parts/1 min and 0.14 parts/1 min, respectively, and when the temperature in the round stainless steel-made flask under the formation of aggregate particles reaches 37.0° C., the tube pumps A and B are driven to start feed of respective dispersion liquids, whereby a mixed dispersion liquid wherein a resin particle and a release agent particle are dispersed therein is fed from the vessel A to the round stainless steel-made flask under the formation of aggregate particles while gradually increasing the concentration of the release agent particle.

The resulting mixture is held for 30 minutes from the time when feed of respective dispersion liquids to the flask is completed and the temperature in the flask reaches 48° C., and a second aggregate particle is thereby formed.

Thereafter, 50 parts of Resin Particle Dispersion Liquid (1D) is slowly added, and the mixture is held for 1 hour. After adjusting the pH to 8.5 by adding an aqueous 0.1 N sodium hydroxide solution, the mixture is heated to 85° C. while continuously stirring, held for 5 hours, then cooled to 20° C. at a rate of 20° C./min, filtered, thoroughly washed with ion-exchanged water, and dried to obtain Toner Particle (1D) having a volume average particle diameter of 6.0 μm.

### [Production of Toner Particle (2D)]

Toner Particle (2D) is obtained in the same manner as Toner Particle (1D) except that in the production of Toner Particle (1D), the liquid feed rate of the tube pump A and the liquid feed rate of the tube pump B are set to 0.56 parts/1 min and 0.11 parts/1 min, respectively, and the tube pumps A and B are driven when the temperature in the flask reaches 32.1° C.

### [Production of Toner Particle (3D)]

Toner Particle (3D) is obtained in the same manner as Toner Particle (1D) except that in the production of Toner Particle (1D), the liquid feed rate of the tube pump A and the liquid feed rate of the tube pump B are set to 0.68 parts/1 min and 0.15 parts/1 min, respectively, and the tube pumps A and B are driven when the temperature in the flask reaches 33.8° C.

### [Production of Toner Particle (4D)]

Toner Particle (4D) is obtained in the same manner as Toner Particle (1D) except that in the production of Toner Particle (1D), the liquid feed rate of the tube pump A and the liquid feed rate of the tube pump B are set to 0.82 parts/1 min and 0.17 parts/1 min, respectively, and the tube pumps A and B are driven when the temperature in the flask reaches 39.4° C.

### [Production of Comparative Toner Particle (C1D)]

Comparative Toner Particle (C1D) is obtained in the same manner as Toner Particle (1D) except that in the production of Toner Particle (1D), the liquid feed rate of the tube pump A and the liquid feed rate of the tube pump B are set to 039 parts/1 min and 0.11 parts/1 min, respectively, and the tube pumps A and B are driven when the temperature in the flask reaches 30.6° C.

### [Production of Comparative Toner Particle (C2D)]

Comparative Toner Particle (C2D) is obtained in the same manner as Toner Particle (1D) except that in the production of Toner Particle (1D), the liquid feed rate of the tube pump A and the liquid feed rate of the tube pump B are set to 0.49 parts/1 min and 0.10 parts/1 min, respectively, and the tube pumps A and B are driven when the temperature in the flask reaches 30.2° C.

### [Production of Comparative Toner Particle (C3D)]

Comparative Toner Particle (C3D) is obtained in the same manner as Toner Particle (1D) except that in the production of Toner Particle (1D), the liquid feed rate of the tube pump A and the liquid feed rate of the tube pump B are set to 1.02 parts/1 min and 0.19 parts/1 min, respectively, and the tube pumps A and B are driven when the temperature in the flask reaches 39.4° C.

### <Production of Titania Particle>

### [Production of Titania Particle (1D)]

Ilmenite ore (FeTiO₃) is heated and dissolved in concentrated sulfuric acid to separate iron powder and obtain TiOSO₄. Furthermore, a precipitate of TiO(OH)₂ is produced through hydrolysis under heating, filtered, repeatedly washed with water, dried at 150° C., and then heated/fired under the conditions of 500° C. and 80 minutes to obtain titanium oxide. The titanium oxide obtained is then dispersed in water, and 5 mass % as solid content of isobutylmethoxysilane is added dropwise with stirring at a temperature of 25° C. The resulting solution is filtered and repeatedly washed with water, and the obtained titanium oxide surface-treated with isobutylmethoxysilane is dried at 150° C. to produce Titania Particle (1D) having a volume average particle diameter of 40 nm.

### [Production of Titania Particle (2D)]

Titania Particle (2D) having a volume average particle diameter of 30 nm is produced in the same manner as Titania Particle (1D) except that ilmenite ore (FeTiO₃) is heated and dissolved in concentrated sulfuric acid to separate iron powder and obtain TiOSO₄ and furthermore, a precipitate of TiO(OH)₂ is produced through hydrolysis under heating, filtered, repeatedly washed with water, dried at 150° C., and then heated/fired under the conditions of 400° C. and 60 minutes.

### [Production of Titania Particle (3D)]

Titania Particle (3D) having a volume average particle diameter of 50 nm is produced in the same manner as Titania Particle (1D) except that ilmenite ore (FeTiO₃) is heated and dissolved in concentrated sulfuric acid to separate iron powder and obtain TiOSO₄ and furthermore, a precipitate of TiO(OH)₂ is produced through hydrolysis under heating, filtered, repeatedly washed with water, dried at 150° C., and then heated/fired under the conditions of 600° C. and 80 minutes.

### Examples 1D to 6D and Comparative Examples 1D to 4D

### Production of Toner

100 Parts of the toner particle of the type shown in Table 4, the titania particle of the type and the amount (parts) shown in Table 4 and 0.7 parts of dimethylsilicone oil-treated silica particle (RY200, produced by Nippon Aerosil Co., Ltd.) are mixed using a Henschel mixer (peripheral velocity: 30 msec, 3 minutes) to obtain each toner.

### [Production of Developer]

Ferrite particle (average particle diameter: 50 μm): 100 parts

Toluene: 14 parts

Styrene/methyl methacrylate copolymer (copolymerization 3 parts ratio: 15/85):

Carbon black: 0.2 parts

These components except for the ferrite particle are dispersed by a sand mill to prepare a dispersion liquid, and this dispersion liquid is put in a vacuum deaeration-type kneader together with the ferrite particle, stirred while reducing the pressure, and dried to obtain a carrier.

Thereafter, 8 parts of each toner is mixed per 100 parts of the carrier above to obtain a developer.

### <Various Measurements>

With respect to the toner of the developer obtained in each of Examples and Comparative Examples, the mode value and skewness of the distribution of the eccentricity degree B of the release agent domain are measured according to the methods described above. The results are shown in Table 4.

The titania particle of the toner of the developer obtained in each of Examples and Comparative Examples is measured for the volume average particle diameter (in the Table, “D50v”) by the method described above. The results are shown in Table 4.

### <Evaluation>

The following evaluations are performed using the developer obtained in each of Examples and Comparative Examples. The results are shown in Table 4.

The developer obtained in each of Examples and Comparative Examples is left standing for 3 days in a low-temperature low-humidity (temperature: 10° C., humidity: 15% RH) environment. The developer bottle of 700 Digital Color Press (“an apparatus having mounted therein a cleaning blade for cleaning the photoreceptor”, manufactured by Fuji Xerox Co., Ltd.) is filled with the developer, and the following evaluations are carried out using this apparatus in a low-temperature low-humidity (temperature: 10° C., humidity: 15% RH) environment.

### (Evaluation of Fogging)

An image with an image density of 40% is continuously output on 100,000 sheets of C2 paper, and the density in the background part output on 100,000th sheet is measured by an image densitometer X-Rite 938 (manufactured by X-Rite Inc.) and also confirmed with an eye. The measured density is evaluated as the fogging density according to the following criteria based on the observation with an eye.

### —Criteria for Evaluation of Fogging—

G1: The fogging density is less than 0.2 and partial fogging is not observed with an eye.
G2: The fogging density is less than 0.2 but slight fogging is observed with an eye.
G3: The fogging density is less than 0.2 but partial fogging is observed with an eye.
G4: The fogging density is 0.2 or more.

### (Evaluation of Color Streak)

An image with an image density of 20% is continuously output on 100,000 sheets of C2 paper. With regard to the image output on 100 sheets from 99,900th sheet to 100,000th sheet, the generation of a color streak is observed with an eye and evaluated according to the following criteria.

G1: A color streak was not generated.
G2: The number of sheets where a color streak was generated is from 1 to 5.
G3: The number of sheets where a color streak was generated is from 6 to 10.
G4: The number of sheets where a color streak was generated is more than 10.

TABLE 4

| | Toner Particle | | | | | | | |
|---|---|---|---|---|---|---|---|---|
| | | Distribu- | | | | | | |
| | | tion of Ec- | | | | | | |
| | | centricity | | | | | | |
| | | Degree B | | | | | | |
| | | of Release | | | | | | |
| | | Agent | | Titania Particle | | | Evaluation | |
| | | Mode | Skew- | | | D50v | Fog- | Color |
| | No. | Value | ness | No. | Parts | (nm) | ging | Streak |
| Example 1D | (1D) | 0.85 | −0.80 | (1D) | 1.00 | 40 | G1 | G2 |
| Example 2D | (2D) | 0.78 | −1.05 | (1D) | 1.00 | 40 | G2 | G1 |
| Example 3D | (3D) | 0.78 | −0.82 | (1D) | 1.00 | 40 | G1 | G2 |
| Example 4D | (4D) | 0.92 | −0.58 | (1D) | 1.00 | 40 | G1 | G2 |
| Example 5D | (1D) | 0.85 | −0.80 | (2D) | 1.00 | 30 | G1 | G2 |
| Example 6D | (1D) | 0.85 | −0.80 | (3D) | 1.00 | 50 | G2 | G1 |
| Com- | (1D) | 0.85 | −0.80 | — | 0 | — | G4 | G2 |
| parative | | | | | | | | |
| Example 1D | | | | | | | | |
| Com- | (C1D) | 0.65 | −0.62 | (1D) | 1.00 | 40 | G4 | G1 |
| parative | | | | | | | | |
| Example 2D | | | | | | | | |
| Com- | (C2D) | 0.76 | −1.18 | (1D) | 1.00 | 40 | G3 | G2 |
| parative | | | | | | | | |
| Example 3D | | | | | | | | |
| Com- | (C3D) | 0.88 | −0.20 | (1D) | 1.00 | 40 | G1 | G4 |
| parative | | | | | | | | |
| Example 4D | | | | | | | | |

It is seen from the results above that in Examples of the present invention, both evaluations of fogging and color streak are good, compared with Comparative Examples.

What is claimed is:

1. An electrostatic image-developing toner comprising:
a toner particle containing a binder resin and a release agent and having a sea-island structure involving a sea part containing the binder resin and an island part containing the release agent, in which a mode value of the distribution of the eccentricity degree B represented by the following formula (1) of the release agent-containing island part is from 0.75 to 0.98 and a skewness of the distribution of the eccentricity degree B is from −1.10 to −0.50; and
an external additive containing a silica particle having a volume average particle diameter of 80 nm to 200 nm;
wherein a bulk density of the toner is from 0.33 g/cm³ to 0.40 g/cm³:
Eccentricity degree B=2d/D Formula (1):
in formula (1), D is an equivalent-circle diameter (μm) of the toner particle in the cross-sectional observation of the toner particle, and d is a distance (μm) from the gravity center of the toner particle to the gravity center of the release agent-containing island part in the cross-sectional observation of the toner particle.

2. The electrostatic image-developing toner as claimed in claim 1,
wherein an externally added amount of the silica particle is from 1.0 mass % to 4.0 mass % based on the total mass of the toner particle.

3. The electrostatic image-developing toner as claimed in claim 1,
wherein the binder resin is a polyester resin.

4. The electrostatic image-developing toner as claimed in claim 3,
wherein a glass transition temperature (Tg) of the polyester resin is from 50° C. to 80° C.

5. The electrostatic image-developing toner as claimed in claim 3,
wherein a weight average molecular weight (Mw) of the polyester resin is from 5,000 to 1,000,000.

6. The electrostatic image-developing toner as claimed in claim 3,
wherein a number average molecular weight (Mn) of the polyester resin is from 2,000 to 100,000.

7. The electrostatic image-developing toner as claimed in claim 3,
wherein a molecular weight distribution Mw/Mn of the polyester resin is from 1.5 to 100.

8. The electrostatic image-developing toner as claimed in claim 1,
wherein a content of the binder resin is from 40 mass % to 95 mass % based on the entire toner particle.

9. The electrostatic image-developing toner as claimed in claim 1,
wherein a content of the release agent is from 1 mass % to 20 mass % based on the entire toner particle.

10. The electrostatic image-developing toner as claimed in claim 1,
wherein the toner particle is a toner particle having a core/shell structure.

11. The electrostatic image-developing toner as claimed in claim 1,
wherein a volume average particle diameter (D50v) of the toner particle is from 2 μm to 10 μm.

12. The electrostatic image-developing toner as claimed in claim 1,
wherein a shape factor SF1 of the toner particle is from 110 to 150.

13. An electrostatic image developer comprising the electrostatic image-developing toner claimed in claim 1.

14. The electrostatic image developer as claimed in claim 13,
wherein, in the developer, the toner and a carrier is mixed.

15. The electrostatic image developer as claimed in claim 14,
wherein the carrier is a coated carrier coating the surface of a core material composed of a magnetic powder with a coating resin.

16. The electrostatic image developer as claimed in claim 15,
wherein the coating resin contains an electrically conductive particle.

17. The electrostatic image developer as claimed in claim 16,
wherein the electrically conductive particle is carbon black.

18. A toner cartridge storing the electrostatic image-developing toner claimed in claim 1, which is attached to and detached from an image forming apparatus.
